(19) United States
(12) Patent Application Publication
(10) Pub. No.: US 2022/0374787 A1
(43) Pub. Date: Nov. 24, 2022

(54) VIRTUAL INTERLINE PASSENGER SERVICE SYSTEM

(71) Applicant: Air Black Box Technologies LLC, Miami, FL (US)

(72) Inventors: Matthew Ghourdjian, Crestone, CO (US); Hussein Sleiman, Costa Mesa, CA (US); Sowjanya Kaligineedi, Irvine, CA (US); Priyanka Namburu, Brea, CA (US); Bishistha Shrestha, Costa Mesa, CA (US); Hoang Nguyen, Fountain Valley, CA (US); Timothy O'Neil-Dunne, Kirkland, WA (US)

(21) Appl. No.: 17/324,045

(22) Filed: May 18, 2021

(51) Int. Cl. G06Q 10/02; G06Q 10/08; G06F 16/172

(52) U.S. Cl. CPC G06Q 10/02; G06Q 10/087; G06F 16/172

(57) ABSTRACT

A virtual passenger service system may aggregate inventory data from various vendors by interfacing with the passenger service system of each vendor. The inventory data may be maintained in an in-memory, graph-based cache in which the inventory data is represented as a collection of interconnected nodes corresponding to airports, departure dates, airlines, flights, and arrival dates. To prevent data decay, contents in the cache may be refreshed on-demand and in accordance with a dynamically determined schedule. Interline itineraries generated by searching the cache may be refined based on vendor specific pricing, routing, and fare construction rules. The virtual passenger service system may include a machine learning model to support the dynamic pricing of interline itineraries. The virtual passenger service system may further support the partial modification of an interline itinerary, which may be realized without canceling and rebooking the interline itinerary in its entirety.

### TECHNICAL FIELD

The subject matter described herein relates generally to airline distribution and more specifically to a virtual passenger service system with optimal interlining support.

### BACKGROUND

Interline refers to a relationship between airlines that allows one airline to sell products and/or services provided by another airline. An interline itinerary would typically include products and services from multiple airlines. For example, an interline itinerary may include at least one journey in which a first segment is serviced by a first airline and a second segment is serviced by a second airline. Interlining enables the first airline to sell this itinerary even though the first airline is unable to serve the entire itinerary by itself In addition to airfare, some interline itinerary may also bundle ancillary products and services such as baggage and seating during the booking process, or hotel accommodations, car rentals, cruises, and attractions and entertainment. As such, interlining may provide the opportunity for an airline to participate in markets and reach customers otherwise inaccessible to the airline.

### SUMMARY

Systems, methods, and articles of manufacture, including computer program products, are provided for processing an interline request. In some example embodiments, there is provided a system that includes at least one processor and at least one memory. The at least one memory may include program code that provides operations when executed by the at least one processor. The operations may include: receiving an interline request associated with a first vendor and a second vendor; responding to an interline request by at least executing a first set of instructions included in a first workbook associated with the interline request, the executing of the first set of instructions includes identifying the first vendor and the second vendor; executing a second set of instructions included in a second workbook associated with the first vendor and a third set of instructions included in a third workbook associated with the second vendor; and generating, based at least on a result of executing the first set of instructions, the second set of instructions, and the third set of instructions, a response for the interline request.

In some variations, one or more features disclosed herein including the following features can optionally be included in any feasible combination. The interline request may include a shopping request to generate an interline itinerary containing a plurality of services and/or products provided by the first vendor and the second vendor.

In some variations, the response for the interline request may include a New Distribution Capability (NDC) offer with a plurality of New Distribution Capability (NDC) offer items corresponding to the plurality of services and/or products provided by the first vendor and the second vendor.

In some variations, the executing of the first set of instructions may further include searching a cache containing inventory data associated with the first vendor and the second vendor in order to generate the interline itinerary.

In some variations, the interline request may include a booking request to purchase an interline itinerary containing a plurality of services and/or products provided by the first vendor and the second vendor.

In some variations, the executing of the first set of instructions may further include interacting with a first passenger service system (PSS) of the first vendor, a second passenger service system (PSS) of the second vendor, and a payment gateway in order to purchase the interline itinerary.

In some variations, the second workbook and the third workbook may be embedded within the first workbook.

In some variations, the executing of the second set of instructions included in the second workbook may further include executing a fourth set of instructions included in a fourth workbook embedded within the second workbook.

In some variations, the executing of the first set of instructions may further include executing, based at least on the interline itinerary being associated with the first vendor and the second vendor, the second set of instructions included in the second workbook and the third set of instructions included in the third workbook but not a fourth set of instructions included in a fourth workbook associated with a third vendor.

In some variations, the operations may further include: in response to the interline request being a shopping request, executing the first set of instructions included in the first workbook; and in response to the interline request being a booking request, executing a fourth set of instructions included in a fourth workbook.

In some variations, the executing of the second set of instructions may include applying a first rule associated with the first vendor to generate the response to the interline request. The executing of the third set of instructions may include applying a second rule associated with the second vendor to generate the response to the interline request.

In some variations, the first rule may include a pricing rule, a routing rule, and/or a fare construction rule imposed by the first vendor. The second rule may include a pricing rule, a routing rule, and/or a fare construction rule imposed by the second vendor.

In some variations, the executing of the second set of instructions may include making one or more calls of a first application programming interface (API) to interact with a first passenger service system (PSS) of the first vendor. The executing of the third set of instructions may include making one or more calls of a second application programming interface (API) to interact with a second passenger service system (PSS) of the second vendor.

In some variations, the interline request may be received at a booking engine of the first vendor to trigger the generation and/or purchase of an interline itinerary that includes products and/or services provided by the first vendor and the second vendor.

In another aspect, there is provided a method for processing an interline request. The method may include: receiving an interline request associated with a first vendor and a second vendor; responding to an interline request by at least executing a first set of instructions included in a first workbook associated with the interline request, the executing of the first set of instructions includes identifying the first vendor and the second vendor; executing a second set of instructions included in a second workbook associated with the first vendor and a third set of instructions included in a third workbook associated with the second vendor; and generating, based at least on a result of executing the first set of instructions, the second set of instructions, and the third set of instructions, a response for the interline request.

In some variations, one or more features disclosed herein including the following features can optionally be included in any feasible combination. The interline request may include a shopping request to generate an interline itinerary containing a plurality of services and/or products provided by the first vendor and the second vendor.

In some variations, the response for the interline request may include a New Distribution Capability (NDC) offer with a plurality of New Distribution Capability (NDC) offer items corresponding to the plurality of services and/or products provided by the first vendor and the second vendor.

In some variations, the executing of the first set of instructions may further include searching a cache containing inventory data associated with the first vendor and the second vendor in order to generate the interline itinerary.

In some variations, the interline request may include a booking request to purchase an interline itinerary containing a plurality of services and/or products provided by the first vendor and the second vendor.

In another aspect, there is provided a computer program product that includes a non-transitory computer readable medium storing instructions. The instructions may cause operations when executed by at least one data processor. The operations may include: receiving an interline request associated with a first vendor and a second vendor; responding to an interline request by at least executing a first set of instructions included in a first workbook associated with the interline request, the executing of the first set of instructions includes identifying the first vendor and the second vendor; executing a second set of instructions included in a second workbook associated with the first vendor and a third set of instructions included in a third workbook associated with the second vendor; and generating, based at least on a result of executing the first set of instructions, the second set of instructions, and the third set of instructions, a response for the interline request.

Systems, methods, and articles of manufacture, including computer program products, are provided for graph-based inventory management. In some example embodiments, there is provided a system that includes at least one processor and at least one memory. The at least one memory may include program code that provides operations when executed by the at least one processor. The operations may include: fetching, from a plurality of vendors, inventory data; populating a cache with a graphical representation of the inventory data, the graphical representation including a plurality of nodes corresponding to airports, departure dates, flight, vendors, and arrival dates, and the graphical representation further including a plurality of edges representative of a relationship between airports, departure dates, flight, vendors, and arrival dates; and searching the cache to generate, based at least on the search, an interline itinerary including a first flight operated by a first vendor and a second flight operated by a second vendor.

In some variations, one or more features disclosed herein including the following features can optionally be included in any feasible combination. The interline itinerary may be generated in response to a request specifying an origin, a destination, and a travel date.

In some variations, the searching of the cache may include identifying a first node representative of a first airport corresponding to the origin, a second node representative of a second airport corresponding to the destination, and a third node representative of the first vendor. The third node may be connected by a first edge to the first node to indicate that the first vendor operates one or more flights departing from the first airport.

In some variations, the searching of the cache may further include identifying a fourth node corresponding to the travel date. The fourth node may be connected by a second edge to the third node to indicate that the first vendor operates one or more flights departing from the first airport on the travel date.

In some variations, the searching of the cache may further include identifying a fifth node corresponding to the first flight. The fifth node may be connected by a third edge to the fourth node to indicate that the first flight departs on the travel date from the first airport.

In some variations, the fifth node may be connected by a fourth edge to a sixth node corresponding to a third airport. The second flight may provide a first connection from the third airport to the second airport corresponding to the second node.

In some variations, the generating of the interline itinerary may include eliminating, based at least on a minimum connection time, a third flight providing a second connection from third airport to the second airport.

In some variations, the searching of the cache may further include applying, at the sixth node and/or a seventh node corresponding to the third flight, one or more filter rules to determine whether to generate the interline itinerary to include the third airport and/or the third flight.

In some variations, the one or more filter rules may include a pricing rule, a fare construction rule, a routing rule, and/or a through-checked baggage rule.

In some variations, the fifth node may be connected by a fourth edge to a sixth node corresponding to one or more rules for pricing the flight associated with the fifth node. A price for the interline itinerary may be determined by at least applying the one or more rules.

In some variations, the operations may further include in response to the request, re-fetching, from the plurality of vendor, expired inventory data.

In some variations, each of the plurality of nodes may be associated with a time-to-live (TTL). The re-fetching of expired inventory data may include re-fetching inventory data associated with one or more nodes having an expired time-to-live.

In some variations, the time-to-live associated with each of the plurality of nodes may be adjusted based on a type of content, vendor practices, and market conditions such that a first one of the plurality of nodes is associated with a different length time-to-live than a second one of the plurality of nodes.

In some variations, the cache may include an in-memory database.

In some variations, the interline itinerary may include a New Distribution Capability (NDC) offer with a first New Distribution Capability (NDC) offer item corresponding to the first flight and a second New Distribution Capability (NDC) offer item corresponding to the second flight.

In some variations, the inventory may be fetched by making one or more application programming interface (API) calls to interact with a passenger service system (PSS) of each of the plurality of vendors.

In another aspect, there is provided a method for graph-based inventory management. The method may include: fetching, from a plurality of vendors, inventory data; populating a cache with a graphical representation of the inventory data, the graphical representation including a plurality of nodes corresponding to airports, departure dates, flight, vendors, and arrival dates, and the graphical representation further including a plurality of edges representative of a relationship between airports, departure dates, flight, vendors, and arrival dates; and searching the cache to generate, based at least on the search, an interline itinerary including a first flight operated by a first vendor and a second flight operated by a second vendor.

In some variations, one or more features disclosed herein including the following features can optionally be included in any feasible combination. The interline itinerary may be generated in response to a request specifying an origin, a destination, and a travel date.

In some variations, the searching of the cache may include identifying a first node representative of a first airport corresponding to the origin, a second node representative of a second airport corresponding to the destination, and a third node representative of the first vendor. The third node may be connected by a first edge to the first node to indicate that the first vendor operates one or more flights departing from the first airport.

In another aspect, there is provided a computer program product that includes a non-transitory computer readable medium storing instructions. The instructions may cause operations when executed by at least one data processor. The operations may include: fetching, from a plurality of vendors, inventory data; populating a cache with a graphical representation of the inventory data, the graphical representation including a plurality of nodes corresponding to airports, departure dates, flight, vendors, and arrival dates, and the graphical representation further including a plurality of edges representative of a relationship between airports, departure dates, flight, vendors, and arrival dates; and searching the cache to generate, based at least on the search, an interline itinerary including a first flight operated by a first vendor and a second flight operated by a second vendor.

Systems, methods, and articles of manufacture, including computer program products, are provided for dynamic pricing. In some example embodiments, there is provided a system that includes at least one processor and at least one memory. The at least one memory may include program code that provides operations when executed by the at least one processor. The operations may include: applying a machine learning model to determine, based at least on one or more factors associated with an interline itinerary, a baseline price for the interline itinerary, the interline itinerary including a first flight operated by a first vendor and a second flight operated by a second vendor; adjusting, based at least on one or more competitive fares, the baseline price for the interline itinerary; adjusting the baseline price for the interline itinerary by applying one or more vendor specific rules associated with the first vendor and/or the second vendor; and generating an offer including the interline itinerary at the adjusted price.

In some variations, one or more features disclosed herein including the following features can optionally be included in any feasible combination. The machine learning model may include a neural network, a regression model, an instance-based model, a regularization model, a decision tree, a random forest, a Bayesian model, a clustering model, an associative model, a deep learning model, a dimensionality reduction model, and/or an ensemble model.

In some variations, the operations may further include: identifying a plurality of interline itineraries that are requested at above-threshold frequency; generating training data including a price and the one or more factors associated with each of the plurality of interline itineraries; and training, based at least on the training data, the machine learning model.

In some variations, the operations may further include: determining, based at least on current market data, the one or more competitive fares, the one or more competitive fares having with a same origin, a same destination, and a same travel date as the interline itinerary.

In some variations, the baseline price may be adjusted to not exceed a price of a non-interlined itinerary and/or a price of another interline itinerary having fewer intermediary stops than the interline itinerary.

In some variations, the current market data may be retrieved by making one or more application programming interface (API) calls associated with a search engine and/or a travel aggregator.

In some variations, the one or more vendor specific rules may be applied to adjust the baseline price of the interline itinerary by at least adjusting a first price of the first flight and/or a second price of the second flight.

In some variations, the one or more vendor specific rules may specify a maximum price and/or a minimum price.

In some variations, the one or more vendor specific rules may specify an increment for each adjustment of the baseline price.

In some variations, the one or more vendor specific rules may specify a bundled discount for an addition of an ancillary product and/or service to the interline itinerary.

In some variations, the one or more factors may include an origin, a destination, a date of travel, a season of travel, a current condition, market conditions, a flight operation cost, and a theoretical price per seat.

In some variations, the offer may include a New Distribution Capability (NDC) offer with a first New Distribution Capability (NDC) offer item corresponding to the first flight and a second New Distribution Capability (NDC) offer item corresponding to the second flight.

In another aspect, there is provided a method for dynamic pricing. The method may include: applying a machine learning model to determine, based at least on one or more factors associated with an interline itinerary, a baseline price for the interline itinerary, the interline itinerary including a first flight operated by a first vendor and a second flight operated by a second vendor; adjusting, based at least on one or more competitive fares, the baseline price for the interline itinerary; adjusting the baseline price for the interline itinerary by applying one or more vendor specific rules associated with the first vendor and/or the second vendor; and generating an offer including the interline itinerary at the adjusted price.

In some variations, one or more features disclosed herein including the following features can optionally be included in any feasible combination. The machine learning model may include a neural network, a regression model, an instance-based model, a regularization model, a decision tree, a random forest, a Bayesian model, a clustering model, an associative model, a deep learning model, a dimensionality reduction model, and/or an ensemble model.

In some variations, the operations may further include: identifying a plurality of interline itineraries that are requested at above-threshold frequency; generating training data including a price and the one or more factors associated with each of the plurality of interline itineraries; and training, based at least on the training data, the machine learning model.

In some variations, the operations may further include: determining, based at least on current market data, the one or more competitive fares, the one or more competitive fares having with a same origin, a same destination, and a same travel date as the interline itinerary.

In some variations, the baseline price may be adjusted to not exceed a price of a non-interlined itinerary and/or a price of another interline itinerary having fewer intermediary stops than the interline itinerary.

In some variations, the current market data may be retrieved by making one or more application programming interface (API) calls associated with a search engine and/or a travel aggregator.

In some variations, the one or more vendor specific rules may be applied to adjust the baseline price of the interline itinerary by at least adjusting a first price of the first flight and/or a second price of the second flight.

In another aspect, there is provided a computer program product that includes a non-transitory computer readable medium storing instructions. The instructions may cause operations when executed by at least one data processor. The operations may include: applying a machine learning model to determine, based at least on one or more factors associated with an interline itinerary, a baseline price for the interline itinerary, the interline itinerary including a first flight operated by a first vendor and a second flight operated by a second vendor; adjusting, based at least on one or more competitive fares, the baseline price for the interline itinerary; adjusting the baseline price for the interline itinerary by applying one or more vendor specific rules associated with the first vendor and/or the second vendor; and generating an offer including the interline itinerary at the adjusted price.

Systems, methods, and articles of manufacture, including computer program products, are provided for interline order modification. In some example embodiments, there is provided a system that includes at least one processor and at least one memory. The at least one memory may include program code that provides operations when executed by the at least one processor. The operations may include: generating an audit trail for a workflow that is executed to generate and/or purchase an interline itinerary; detecting a change associated with the interline itinerary; and responding to the change by at least unwinding, based at least on the audit trail, the executed workflow from an end of the executed workflow to a point of the change.

In some variations, one or more features disclosed herein including the following features can optionally be included in any feasible combination. The audit trail may include a sequence of operations that were performed to generate and/or to purchase the interline itinerary. The unwinding of the executed workflow may include undoing, starting at the point of the change, one or more operations in the sequence of operations.

In some variations, the operations may further include: responding to the change by at least replaying the workflow starting from the point of the change, the replaying of the workflow including performing, starting at the point of the change, the one or more operations in the sequence of operations.

In some variations, the replaying of the workflow may generate a modified interline itinerary. The modified interline itinerary may be provided as a New Distribution Capability (NDC) offer with one or more New Distribution Capability (NDC) offer items corresponding to one or more flights included in the modified interline itinerary.

In some variations, the unwinding and the replaying of the workflow may include making one or more application programming interface (API) calls to an external passenger service system and/or payment gateway.

In some variations, the audit trail may include one or more decisions made as part of the workflow, one or more actions taken in response to the one or more decisions, a context associated with the one or more decision, one or more rules associated with the one or more decisions, one or more application programming interface (API) calls to trigger the one or more actions at a passenger service system, and a response to the one more application programming interface (API) calls.

In some variations, the operations may include: storing a plurality of audit trails including the audit trail, the stored plurality of audit trails being sorted based on a date and/or a time associated with each of the plurality of audit trails.

In some variations, the change associated with the interline itinerary may include a rescheduling and/or a cancellation of one or more of a plurality of flights included in the interline itinerary.

In some variations, the change may be initiated by a customer associated with the interline itinerary and/or a vendor providing a service and/or a product included in the interline itinerary.

In some variations, the unwinding may enable the interline itinerary to undergo a partial change without being canceled in its entirety.

In another aspect, there is provided a method for interline order modification. The method may include: generating an audit trail for a workflow that is executed to generate and/or purchase an interline itinerary; detecting a change associated with the interline itinerary; and responding to the change by at least unwinding, based at least on the audit trail, the executed workflow from an end of the executed workflow to a point of the change.

In some variations, one or more features disclosed herein including the following features can optionally be included in any feasible combination. The audit trail may include a sequence of operations that were performed to generate and/or to purchase the interline itinerary. The unwinding of the executed workflow may include undoing, starting at the point of the change, one or more operations in the sequence of operations.

In some variations, the operations may further include: responding to the change by at least replaying the workflow starting from the point of the change, the replaying of the workflow including performing, starting at the point of the change, the one or more operations in the sequence of operations.

In some variations, the replaying of the workflow may generate a modified interline itinerary. The modified interline itinerary may be provided as a New Distribution Capability (NDC) offer with one or more New Distribution Capability (NDC) offer items corresponding to one or more flights included in the modified interline itinerary.

In some variations, the unwinding and the replaying of the workflow may include making one or more application programming interface (API) calls to an external passenger service system and/or payment gateway.

In some variations, the audit trail may include one or more decisions made as part of the workflow, one or more actions taken in response to the one or more decisions, a context associated with the one or more decision, one or more rules associated with the one or more decisions, one or more application programming interface (API) calls to trigger the one or more actions at a passenger service system, and a response to the one more application programming interface (API) calls.

In some variations, the operations may include: storing a plurality of audit trails including the audit trail, the stored plurality of audit trails being sorted based on a date and/or a time associated with each of the plurality of audit trails.

In some variations, the change associated with the interline itinerary may include a rescheduling and/or a cancellation of one or more of a plurality of flights included in the interline itinerary.

In some variations, the change may be initiated by a customer associated with the interline itinerary and/or a vendor providing a service and/or a product included in the interline itinerary.

In another aspect, there is provided a computer program product that includes a non-transitory computer readable medium storing instructions. The instructions may cause operations when executed by at least one data processor. The operations may include: generating an audit trail for a workflow that is executed to generate and/or purchase an interline itinerary; detecting a change associated with the interline itinerary; and responding to the change by at least unwinding, based at least on the audit trail, the executed workflow from an end of the executed workflow to a point of the change.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein.

Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A depicts a block diagram illustrating an example of a virtual interline passenger service system, in accordance with some example embodiments.

FIG. 1B depicts another block diagram illustrating an example of a virtual interline passenger service system, in accordance with some example embodiments;

FIG. 2A depicts an example of a graph representative of inventory data, in accordance with some example embodiments;

FIG. 2B depicts an example of a search through a graph representative of inventory data to generate an interline schedule, in accordance with some example embodiments;

FIG. 2C depicts various examples of interline itineraries between an origin and a destination, in accordance with some example embodiments;

FIG. 3 depicts an example of a machine learning model, in accordance with some example embodiments;

FIG. 4A depicts a schematic diagram illustrating an example of a rules engine, in accordance with some example embodiments;

FIG. 4B depicts an example of a user interface associated with a rules engine, in accordance with some example embodiments;

FIG. 5 depicts an example of a user interface, in accordance with some example embodiments;

FIG. 6 depicts a schematic diagram illustrating an example of an event-driven structure for handling hierarchical behavioral logic, in accordance with some example embodiments;

FIG. 7 depicts a schematic diagram illustrating an example of a process for generating travel data, in accordance with some example embodiments;

FIG. 8 depicts a schematic diagram illustrating an example of a rewind-replay process for running “what-if” scenarios against past decisions to validate proposed logic modifications, in accordance with some example embodiments;

FIG. 9 depicts a schematic diagram illustrating an example of an unwind-replay process, in accordance with some example embodiments;

FIG. 10A depicts an example of an interline itinerary, in accordance with some example embodiments;

FIG. 10B depicts an example of a New Distribution Capability (NDC) offer corresponding to an interline request, in accordance with some example embodiments;

FIG. 11A depicts an example of a response to a shopping request, in accordance with some example embodiments;

FIG. 11B depicts an example of a response to a shopping request, in accordance with some example embodiments;

FIG. 12 depicts multiple New Distribution Capability (NDC) offers responsive to an interline request, in accordance with some example embodiments;

FIG. 13 depicts a flowchart illustrating an example of a process for processing an interline request, in accordance with some example embodiments;

FIG. 14 depicts a flowchart illustrating an example of a process for graph-based inventory management, in accordance with some example embodiments;

FIG. 15 depicts a flowchart illustrating an example of a process for dynamic pricing, in accordance with some example embodiments;

FIG. 16 depicts a flowchart illustrating an example of a process for interline order modification, in accordance with some example embodiments; and

FIG. 17 depicts a block diagram illustrating an example of a computing system, in accordance with some example embodiments.

When practical, similar reference numbers denote similar structures, features, or elements.

### DETAILED DESCRIPTION

Through strategic partnerships with other airlines and providers of ancillary services such as baggage and seating during the booking process, hotel accommodations, car rentals, cruises, and attractions and entertainment, interlining may allow an airline to serve more markets and customers. An optimal interlining paradigm requires a technical framework capable of providing rapid and reliable access to each participating airline's passenger service system (PSS) to track inventory, perform bookings, and/or the like. However, various incompatibilities between different passenger service systems (e.g., mismatched data formats and/or the like) have thwarted efforts to successfully integrate, for example, a first airline's passenger service system with a second airline's passenger service system such that the first airline and/or the second airline are able to sell interline itineraries with services from both airlines.

The challenges associated with integrating different passenger service systems have to date engendered less than optimal integration solutions. For example, conventional integration solutions fail to maintain a combined schedule, fare, and availability inventory with minimal data decay and maximum search efficiency. As such, conventional interline itineraries are generated with excessive delay and no guarantee on either availability or pricing. Conventional interlining solutions also do not support dynamic pricing in which the price of at least one journey, segment, and/or leg forming an interline itinerary is determined in real time. Dynamic pricing may provide the ability to apply, in real time, incentives to encourage the purchase of fares such as special pricing to distressed inventory (e.g., fares that are near the travel date). The lack of dynamic pricing support may deprive an airline the flexibility of pricing according to up-to-the-minute market conditions when participating as an interline partner. This inflexibility may further extend to conventional interline itineraries, such as ones generated in the absence of dynamic pricing, at least because any partial change to a conventional interline itinerary would require canceling and rebooking the entire interline itinerary.

To address the various shortcomings associated with conventional integration schemes, various implementations of the current subject matter provide a virtual passenger service system (VPSS) configured to integrate the individual passenger service systems of a single vendor or multiple vendors. As used herein, the term “vendor” may generally refer to any source of a service and/or product that may be included as a part of an interline itinerary. While an airline is one example of a vendor, it should be appreciated that the term “vendor” also contemplates global distribution systems (GDS), travel aggregators, and ancillary providers. Accordingly, the virtual passenger service system (PSS) may include vendor gateways with application programming interfaces (APIs) capable of interfacing, for example, with a first passenger service system of a first airline and a second passenger service system of a second airline. Instead of airlines, the first passenger service system and/or the second passenger service system may be associated with a different vendor or service provider such as a hotel, a car rental agency, a cruise operator, a train operator, a bus operator, and/or the like.

The virtual passenger service system may be configured to maintain, with minimal data decay and maximum search efficiency, a combined inventory with schedules, fares, and/or availabilities from multiple vendors. The virtual passenger service system may gather inventory data (e.g., schedule, fare, availability, and/or the like) from different vendors and expose this inventory data in a standardized manner (e.g., in an Extensible Markup Language (XML) standard such as New Distribution Capability (NDC) standard and/or the like). The standardized inventory data may be available for consumption by various external systems to construct offers with interline itineraries containing products and/or services from multiple vendors.

In some example embodiments, the virtual passenger service system may maintain an in-memory, graph-based cache populated with the inventory data, including schedule, fare, and availability, from multiple vendors. To prevent data decay (e.g., the obsolescence of the inventory data), refreshment of the in-memory, graph-based cache may be demand-driven such that the schedule for updating the contents of the cache may evolve over time based on changes in market conditions. Meanwhile, search speed and efficiency may be maximized by representing the combined inventory data from multiple airlines, including schedule, fare, and availability, as a collection of nodes corresponding to airports, departure dates, airlines, and arrival dates. Connections between the nodes may indicate the relationship between the corresponding airports, departure dates, airlines, and arrival dates. For example, the latency associated with searching the graph-based cache may be minimized by the presence of nodes corresponding to various search criteria at least because these nodes enable the inventory data to be rapidly narrowed down based on the search criteria.

In some example embodiments, the behavior of the virtual passenger service system may be governed by a set of workbooks, each of which defining at least some of the logic for handling certain events. The workbook architecture may be hierarchical, with the set of workbooks being recursively usable abstractions that govern successive layers of behavior at the virtual passenger service system. A workbook may provide a high-level logic implemented at the virtual passenger service system in response to an event such as a shopping request for various interline offers. For example, the workbook may be a data object including a set of instructions that are executed at the virtual passenger service system upon certain events. Executing this high-level logic may trigger additional workbooks providing vendor-specific logic. Workbooks with vendor-specific logic are called playbooks and may encapsulate how the virtual passenger service system interact with each airline's individual passenger service system, the format of the data received from each airline's passenger service system, and how this data is further exposed to various external systems. In some cases, the lower level, vendor-specific logic may inherit at least some high level logic while some high level logic may be overridden at the vendor level. This hierarchical architecture modularizes otherwise complex behavior across a multitude of vendors to afford an infinitely scalable interlining paradigm capable of accommodating vendor-specific logic imposed by any number of vendors. Workbook execution may also be asynchronous, for example, with the vendor-specific logic included in each playbook being executed in parallel to maximize computational speed and efficiency.

Accordingly, to respond to the shopping request for an interline itinerary, for example, the virtual passenger service system may execute the high-level logic included in the workbook. Doing so may trigger the execution of lower level logic such as, for example, vendor-specific logic included in a first playbook associated with a first airline and a second playbook associated with a second airline. For example, executing the high-level logic included in the workbook may include searching the cache for a response before applying the vendor-specific logic included in each of the first playbook and the second playbook to refine the response and generate interline offers that are consistent with the various pricing, routing, and fare construction rules imposed by each of the first airline and the second airline.

In some example embodiments, the execution of logic included in successive hierarchical layers of workbooks and/or playbooks may generate travel data that captures, at the lowest level of invoked logic, the behavior triggered at the virtual passenger service system. Travel data may include, at a fine level of granularity, all portions of a passenger's travel cycle including, for example, flight segments, hotel accommodation, surface transport reservations, car hire, and/or the like. Once an interline offer is booked, the corresponding travel data may be maintained in “state” to enable synchronous updates and real time updates. In particular, the stateful persistence of travel data may enable an interline itinerary to undergo partial modification without being canceled and rebooked in its entirety. For example, the virtual passenger service system may respond to a schedule disruption (e.g., one or more Irregular Operations (IROPS)) or a customer-initiated action by unwinding an interline itinerary to a point affected by the schedule disruption and replaying the interline itinerary forward to provide one or more alternatives.

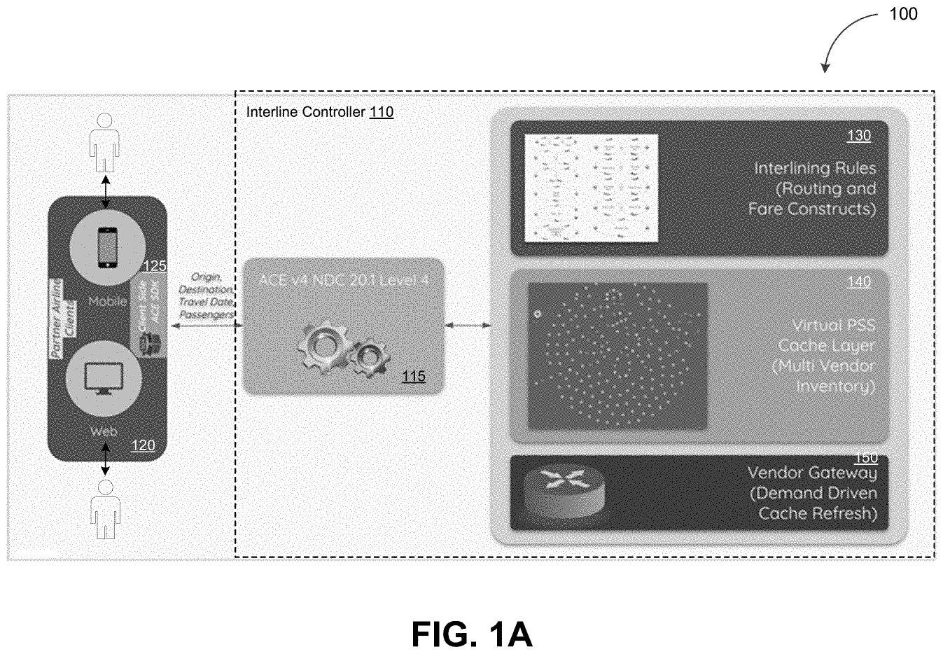

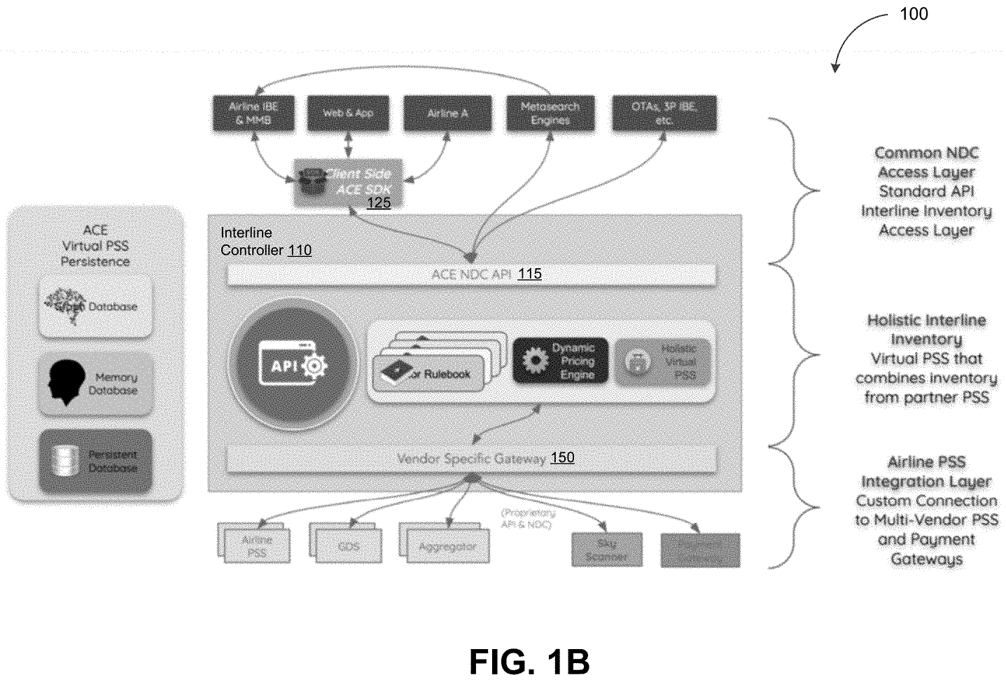

FIG. 1A depicts a system diagram illustrating an example of a virtual interline passenger service system 100, in accordance with some example embodiments. Referring to FIG. 1A, the virtual interline passenger service system 100 may include an interline controller 110 that is communicatively coupled to a client device 120 via, for example, one or more wired networks and/or wireless networks such as a local area network (LAN), a virtual local area network (VLAN), a wide area network (WAN), a public land mobile network (PLMN), and/or the Internet. As shown in FIG. 1A, the interline controller 110 may expose, to the client device 120, a standardized application programming interface (API) 115 such as a New Distribution Capability (NDC) standard based application programming interface. As such, any number of clients, including the client device 120, may interact with the interline controller 110 using a standardized data schema. In some cases, the client device 120 may include a client side software development kit (SDK) 125, which may at least partially implement the application programming interface 115 at the client device 120 to enable interaction with the interline controller 110.

Referring again to FIG. 1A, the interline controller 110 may further include a rules engine 130, a cache 140, and a vendor gateway 150. The client device 120 may be associated with a first vendor, such as a first airline, having an interline relationship with one or more other vendors including, for example, a second vendor and/or the like. The interline relationship may allow the first vendor to sell interline itineraries that bundle products and services from the first vendor and the second vendor. To generate such an interline itinerary, FIG. 1A shows that the customers of the first vendor may send, to the client device 120, a shopping request specifying one or more parameters including, for example, an origin, a destination, a travel date (e.g., a departure date and/or an arrival date), a quantity of passengers, and/or the like. The shopping request may be sent through a booking engine of the first vendor, for example, via a website and/or a mobile application associated with the first vendor (or an aggregator).

The client device 120 may send, to the interline controller 110, the shopping request and the interline controller 110 may respond to the shopping request by searching the cache 140 for a response that includes interline itineraries matching the parameters set forth in the shopping request. The cache 140 may include inventory data, such as schedule, fare, and availability, from multiple vendors including, for example, the first vendor, the second vendor, and/or the like. To maximize search speed and efficiency, the cache 140 may be in-memory and cache-based, with the inventory data being represented as a collection of interconnected nodes corresponding to airports, departure dates, airlines, and arrival dates. The response generated by searching the cache 140 may be refined by a rules engine 130 such that the interline offers provided in response to the shopping request are consistent with the various pricing, routing, and fare construction rules imposed by the first vendor and the second vendor.

In some example embodiments, the interline controller 110 may populate and refresh the cache 140 by at least interacting, through the vendor gateway 150, with the passenger service system (PSS) of each of the first vendor and the second vendor. It should be appreciated that the interline controller 110 may be communicatively coupled with these passenger service systems via one or more wired networks and/or wireless networks. Moreover, the vendor gateway 150 may provide the application programming interfaces (APIs) capable of interfacing with, for example, a first passenger service system of the first vendor and a second passenger service system of the second vendor.

FIG. 1B depicts another block diagram illustrating an example of the virtual interline passenger service system 100, in accordance with some example embodiments. As shown in FIG. 1B, the interline controller 110 may interface with a variety of external systems including, for example, an airline's booking engine (e.g., Internet booking engine (IBE), manage my booking (MMB), and/or the like), a carrier alliance website and/or web application, a metasearch engine (e.g., either directly or indirectly through an airline booking engine), a third party booking engine, an online travel agent, and/or the like.

In the example shown in FIG. 1B, the client side software development kit 125, which enables interaction with the interline controller 110, may be made available to at least some of those external systems including, for example, the airline booking engine, the carrier alliance website and/or web application, and/or the like. Alternatively and/or additionally, some external systems, such as the metasearch engine, the third party booking engine, and the online travel agent, may interact with the interline controller 110 by invoking the application programming interface 115. In either case, the interline controller 110 may provide, to the various external systems, access to a combined inventory with schedules, fares, and/or availabilities from multiple vendors.

To further illustrate, FIG. 1B shows the vendor gateway 150 as providing an interface between the interline controller 110 and a variety of sources of services and/or products including airline passenger service systems, global distribution systems (GDS), aggregators, and ancillary providers (e.g., hotel accommodations, car rentals, cruises, and attractions and entertainment). The vendor gateway 150 may also provide an interface between the interline controller 110 and support service providers such as payment gateways (e.g., with real time settlement capabilities).

In some example embodiments, the interline controller 110 may gather, through the vendor-specific gateway 150, inventory data from a variety of vendors. For example, the vendor gateway 150 may include application programming interfaces (APIs) capable of interfacing with a first passenger service system of a first airline and a second passenger service system of a second airline such that the interline controller 110 is able to gather inventory data from the first airline and the second airline. The inventory data gathered from different vendors may be used to populate and/or refresh the cache 140. For instance, in some example embodiments, the cache 140 may be a graph-based database (e.g., a Neo4J graph database and/or the like) such that the inventory data is represented as a collection of interconnected nodes corresponding to airports, departure dates, flights, airlines, and arrival dates.

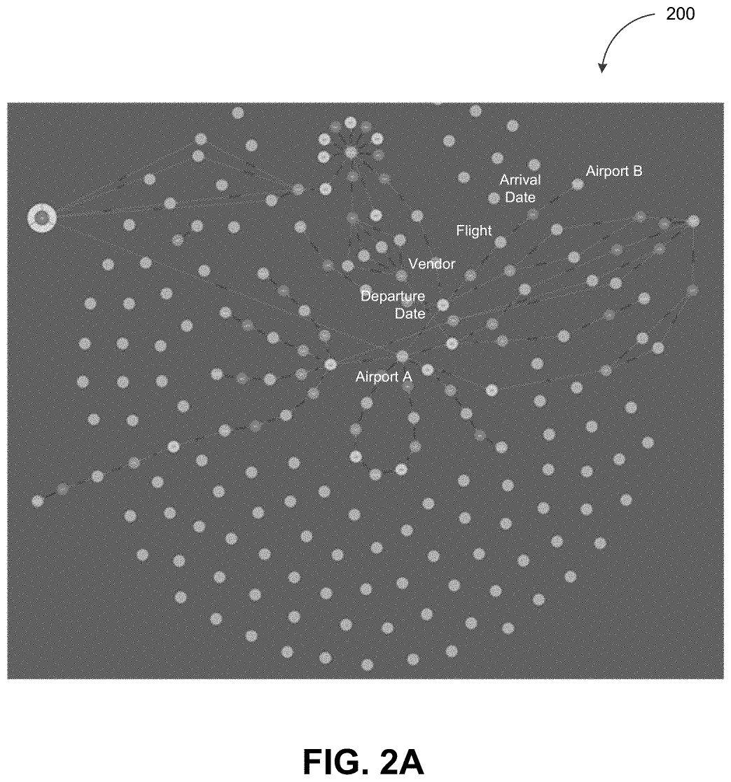

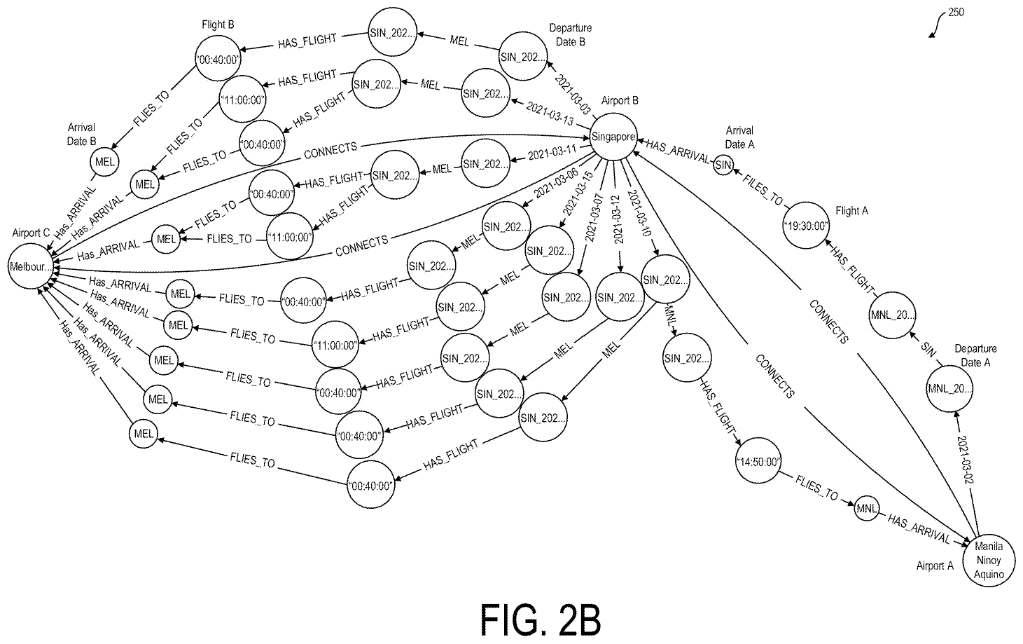

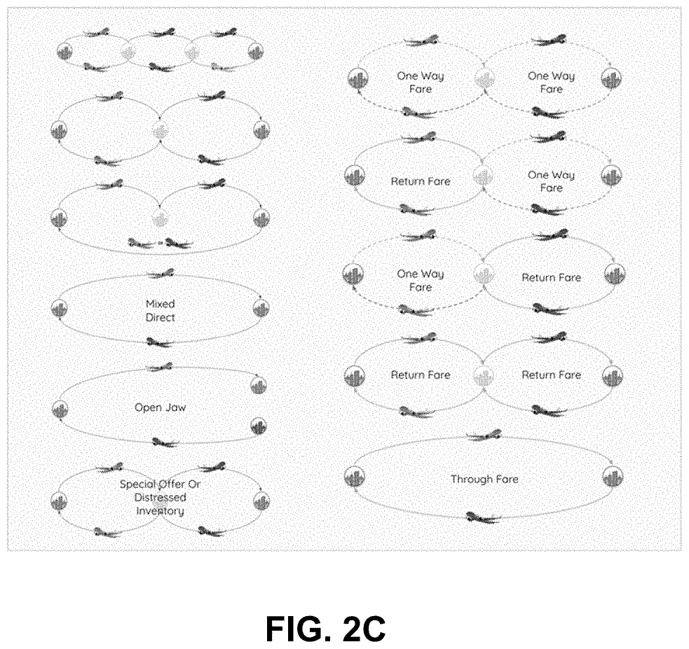

To further illustrate, FIG. 2A depicts an example of a graph 200 representative of inventory data, in accordance with some example embodiments. The graph 200 may include a collection of nodes representative of the combined schedule, fare, and availability inventory of multiple vendors. The graph 200 may further include edges representative of the relationship between different airports, departure dates, flights, airlines, and arrival dates. For example, the graph 200 may include a first node corresponding to a flight, a second node corresponding to a vendor, a third node corresponding to a first airport (Airport A), a fourth node corresponding to a second airport (Airport B), a fifth node corresponding to a departure date, and a sixth node corresponding to an arrival date.

One or more edges between the nodes may indicate that the flight (the first node) operated by the vendor (the second node) may depart on the departure date (the fifth node) and arrive on the arrival date (the sixth node) to provide a connection from the first airport (the third node) to the second airport (the fourth node). The presence of nodes corresponding to various search criteria may minimize the latency associated with searching the cache 140 at least because these nodes enable the inventory data to be rapidly narrowed down based on the search criteria. For example, to identify fares between two airports on a departure date, the inventory data may be searched to locate nodes corresponding to the specified airports and departure date.

In some example embodiments, the interline controller 110 may respond to a shopping request by constructing one or more offers, each of which including an interline itinerary that contains products and/or services provided by multiple vendors. The shopping request may, as noted, specify one or more parameters such as an origin, a destination, a travel date (e.g., a departure date and/or an arrival date), a quantity of passengers, and/or the like. As such, in response to the shopping request, the interline controller 110 may search the cache 140 for interline itineraries matching the parameters specified by the shopping request. For example, the interline controller 110 may construct a schedule with the available inventory of flights connecting, for example, the origin and the destination on the specified travel date. This schedule may be refined based on airport-specific Minimum Connection Time (MCT), for example, to identify and eliminate infeasible connections. Alternatively and/or additionally, the schedule may be refined based on factors such as total availability on each of the flights, fares, and/or the like.

Data decay, in particular the presence of obsolete inventory data in the cache 140, may be minimized by the interline controller 110 refreshing the cache 140 on a demand-driven basis. For example, instead of a fixed schedule for refreshing the contents of the cache 140, the schedule for updating the contents of the cache 140 may evolve over time in response to changes in vendor practice, market conditions, and/or the like. Moreover, some contents in the cache 140 may exhibit more stability than others. For example, the presence of Airport A and Airport B may be less susceptible to fluctuations than the pricing and/or availability of flights between Airport A and Airport B. Accordingly, the dynamically determined refresh schedule indicates that a first content (e.g., the first node corresponding to the flight between Airport A and Airport B) in the cache 140 is invalid after an x quantity of time while a second content in the cache 140 (e.g., the third node corresponding to Airport A and/or the fourth node corresponding to Airport B) may be invalid after a y quantity of time. That is, different content (or different types of content) in the cache 140 may be associated with a different time-to-live (TTL). Attempts the read the cache 140 may trigger a re-fetching, through the vendor gateway 150, of the expired contents (e.g., nodes with an expired time-to-live (TTL)) from the corresponding vendor passenger service systems.

FIG. 2B depicts an example of a search through a graph 250 representative of inventory data to generate an interline itinerary, in accordance with some example embodiments. The graph 250 may correspond to a portion of the inventory data that includes candidate itineraries that from Airport A and Airport C that departs on Departure Date A and includes a user-specified maximum quantity of intermediate stops. In the example shown in FIG. 2B, the graph 250 may itself be the result of a previous search in which the graph 200 representative of the combined schedule, fare, and availability inventory of multiple vendors is traversed to identify possible itineraries between Airport A and Airport C that departs on Departure Date A and includes at most a single intermediate stop. As shown in FIG. 2B, these candidate itineraries may include one or more interline itineraries that connects through Airport B. Although not shown, it should be appreciated that the candidate itineraries may also include direct flights from Airport A and Airport C as well as interline itineraries with an intermediary stop at a different Airport and/or additional intermediary stops.

Referring again to FIG. 2B, the search through the graph 250 may be filter-based. For example, the itineraries that are ultimately presented as the results of a shopping request may be determined by traversing the graph 250 with a filter that applies, at each node, one or more applicable rules. A candidate itinerary may be eliminated if the candidate itinerary contains a node that violates one or more filter rules, which may be specified in the shopping request, by an airline, an airport authority, and/or the like. Filter rules may therefore control the various parameters of a possible itinerary that is returned to a user associated with the shopping request. Examples of filter rules may include an airport-specific Minimum Connection Time (MCT), total availability on a flight, fare restrictions, connection restrictions, and/or the like. Some filter rules may dictate the availability of ancillary services such as through-checked baggage. For example, one or more candidate itineraries may be eliminated as a result of applying the through-checked bagged requirement when traversing the graph 250 if an airport, an airline, and/or a flight does not support through-checked baggage.

FIG. 2C depicts various examples of interline itineraries between an origin and a destination that may be constructed by the interline controller 110 and provided, for example, as possible offers responsive to a shopping request. According to some example embodiments, a single interline itinerary may include one or more journeys with each journey including one or more segments and each segment further including one or more legs. As shown in FIG. 2C, the journeys, segments, and legs forming an interline itinerary may be serviced by multiple vendors.

As noted, the interline controller 110 may respond to a shopping request by at least searching, based on the parameters specified in the shopping request, the cache 140 in order to construct various offers with interline itineraries that contain products and/or services from multiple vendors. Furthermore, to generate the offers, the interline controller 110, for example, the rules engine 130, may refine the results from the cache 140 by applying the pricing, routing, and fare construction rules imposed by each vendor. In some example embodiments, the interline controller 110 may implement strategies to accelerate the dynamic generation of interline offers such that these offers may be available with minimal delay. Interline itineraries may include at least some routes that are unscheduled flights, which are not published and lack predetermined pricing. As such, interline offer generation may require the evaluation of various flight path options, price determination, application of carrier display rules, and publication of the interline offers to be performed in a minimal quantity of time (e.g., 5 milliseconds or less). Various implementations of the current subject matter accelerate the generation of interline offers, including the dynamic pricing of interline itineraries, in order to satisfy these strict time constraints. The ability to dynamically price interline itineraries may also increase the flexibility and competitiveness of participating vendors, who are otherwise required to apply static, bucket pricing to fares.

In some example embodiments, strategies to accelerate the dynamic generation of interline offers may include a machine learning based approach to dynamic pricing. For example, the interline controller 110 may train a machine learning model to determine, for an interline itinerary, a pricing that takes into account a variety of factors associated with the interline itinerary including, for example, an origin, a destination, a date of travel, a season of travel, current conditions, market conditions, flight operation costs, theoretical price per seat, and/or the like.

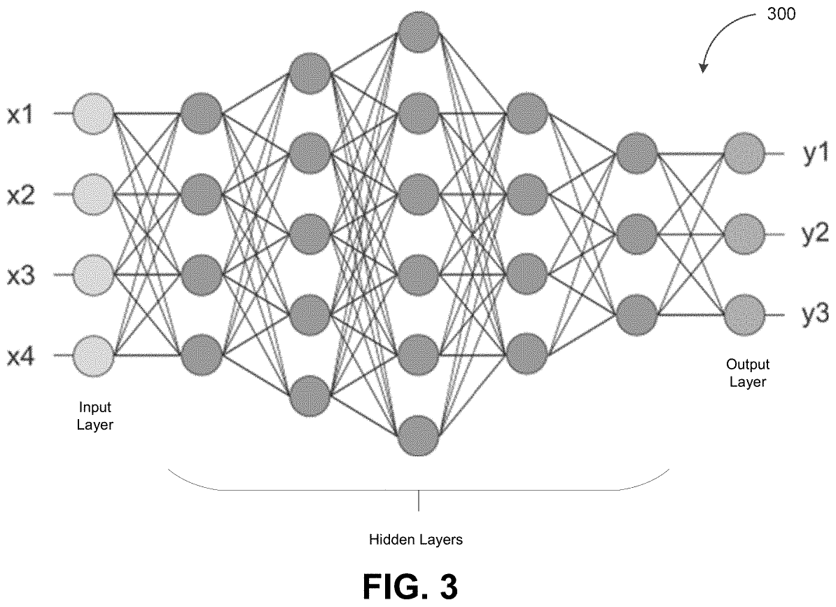

FIG. 3 depicts one example of a machine learning model, in accordance with some example embodiments. The machine learning model shown in FIG. 3 is a neural network 300 having successive layers of neurons. Instead of and/or in addition to the neural network shown in FIG. 3, it should be appreciated that the interline controller 110 may apply other types of machine learning models for dynamic pricing including a regression model, an instance-based model, a regularization model, a decision tree, a random forest, a Bayesian model, a clustering model, an associative model, a dimensionality reduction model, an ensemble model, and/or the like.

Referring again to FIG. 3, the neural network 300 may receive, at an input layer, inputs (x₁, x₂, x₃, x₄, . . . , xₙ) corresponding to the various factors that may affect the pricing of an interline itinerary including, for example, an origin, a destination, a date of travel, a season of travel, current conditions, market conditions, flight operation costs, theoretical price per seat, and/or the like. Moreover, the neural network 300 may generate, at an output layer, outputs (y₁, y₂, y₃, . . . , yₘ) corresponding to a predicted price of the interline itinerary. The neurons occupying each hidden layer of the neural network 300 may apply an activation function f to the weighted sum of the values received from the neurons in a preceding layer of the neural network. Examples of activation functions include a sigmoid function, a hyperbolic function, a rectified linear unit (ReLU) function, a maximum function, and an exponential linear unit (ELU) function.

The interline controller 110 may train the neural network 300 using training data that includes popular interline itineraries. For example, the interline controller 110 may track the frequency at which an interline itinerary is provided as a response to the shopping requests received at the interline controller 110. Interline itineraries that are used at an above-threshold frequency may be identified as training data and thus held in the cache 140, for example, without being subject to any data decay rules. The neural network 300 may therefore be trained using interline itineraries that are encountered at the virtual passenger service system 100 at an above-threshold frequency. The training data may include, for example, various factors associated with each of the popular itineraries such that the neural network 300 is trained to recognize the relationship between these factors and the pricing of the interline itinerary. The neural network 300 may be trained using historical data (e.g., the saved popular itineraries) but it should be appreciated that the neural network 300 may also be updated in real time using interline itineraries responsive to incoming requests.

The neural network 300 may be trained in a supervised manner and/or an unsupervised manner. In the former case, the neural network 300 may be trained by at least minimizing an error in the output of the neural network 300. This error may correspond to a difference between the output of the neural network 300 processing the interline itineraries forming the training data and a correct output associated with each interline itinerary. For example, the training may include determining a gradient of an error function (e.g., mean squared error (MSE), cross entropy, and/or the like) quantifying an error in the output of the neural network 300. The gradient of the error function may be determined by backward propagating the error in the output of the neural network 300. Moreover, the error in the output of the neural network 300 may be minimized by at least updating weights (and biases) applied by the neurons in the neural network 300 until the gradient of the error function converges, for example, to a local minimum and/or another threshold value.

As noted, the interline controller 110 may respond to a shopping request by at least searching the cache 140 for interline itineraries matching the parameters specified in the shopping request. Furthermore, the interline controller 110 may construct offers corresponding to the matching interline itineraries identified through the search of the cache 140. In some example embodiments, the construction of an interline offer including an interline itinerary may include determining a baseline pricing for the interline itinerary by applying the trained machine learning model (e.g., the neural network 300 and/or the like) to the interline itinerary, including the various factors associated with the interline itinerary (e.g., an origin, a destination, a date of travel, a season of travel, current conditions, market conditions, flight operation costs, theoretical price per seat, and/or the like). The baseline pricing for the interline itinerary may be further refined, for example, by the rules engine 130, based on defined system behavior, query context, and/or vendor-specific rules before being provided as part of an interline offer.

In some example embodiments, the dynamic pricing of an interline itinerary, including the refining of a baseline pricing (e.g., determined by a trained machine learning model such as the neural network 300), may include adjusting the pricing for the interline itinerary based on one or more competitive fares. The interline controller 110, for example, the rules engine 130, may adjust the pricing for one or more flights included in an interline itinerary from an origin to a destination on a certain travel date such that the interline itinerary is not priced above (or below) comparable itineraries from the origin to the destination on the same travel date, particularly other interline itineraries with fewer intermediary stops and/or non-interlined itineraries providing a direct connection between the origin and the destination. Such adjustments may be made based on prevailing market fares (or fare ranges), which may be determined based on current market data obtained from a variety of sources. Referring again to FIG. 1B, the interline controller 110 may interface with these sources, such as search engines and travel aggregators, through application programming interfaces (APIs) provided by the vendor gateway 150.

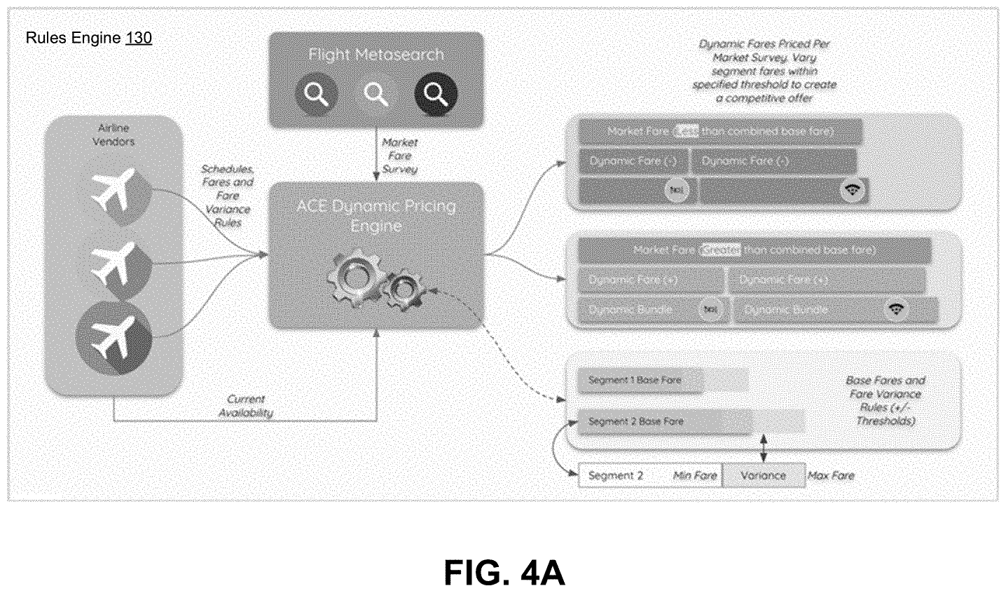

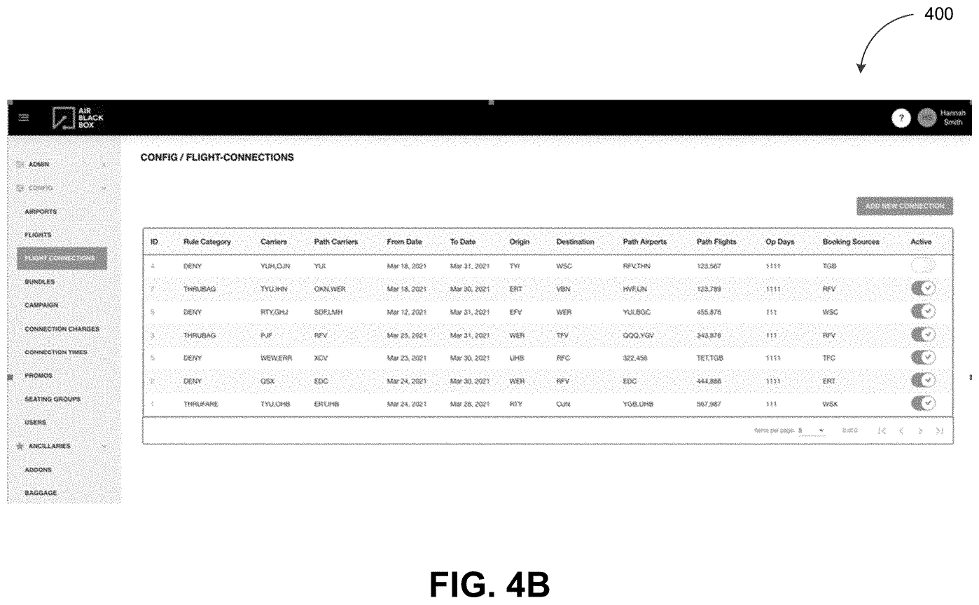

To further illustrate how the interline controller 110 performs dynamic pricing, FIG. 4A depicts a schematic diagram illustrating an example of the rules engine 130, in accordance with some example embodiments. According to some example embodiments, the interline controller 110 may track inventory data from multiple vendors (e.g., in the cache 140) as well as the pricing for various interline itineraries including, for example, the baseline pricing determined by the trained machine learning model (e.g., the neural network 300 and/or the like). To generate an offer including an interline itinerary having multiple segments serviced by different vendors, the interline controller 110, for example, the rules engine 130, may apply one or more strategies to adjust the pricing for one or more segments of the interline itinerary and/or the pricing for the interline itinerary as a whole. As one example, based on prevailing market conditions (e.g., higher or lower competitive fares), the rules engine 130 may adjust (e.g., increase or decrease) the price for a segment of the interline itinerary by an increment (e.g., a fraction and/or the like) specified by the vendor servicing the segment. In some cases, these adjustments may be bound by one or more price thresholds (e.g., a maximum price and/or a minimum price) set by the vendor. Alternatively and/or additionally, the rules engine 130 may adjust the pricing of the interline itinerary as a whole including by providing bundled discounts for various ancillary products and/or services included in the interline itinerary.

At least some of the rules for determining the price of a segment of an interline itinerary may be maintained in the cache 140, for example, as one or more nodes connected to a node representative of the segment. Referring back to FIG. 2A, the first node corresponding to the flight may be further connected to one or more additional nodes, each of which corresponding to at least one of the rules for determining the price of the flight. For example, the first node corresponding to the flight may be connected to a seventh node corresponding to a rule to adjust (e.g., increase or decrease) the price for the flight by a quantity (e.g., a fraction and/or the like) specified by the vendor associated with the second node. Alternatively and/or additionally, the first node corresponding to the flight may be connected to an eighth node corresponding to another rule setting one or more price thresholds (e.g., a maximum price and/or a minimum price) for the flight. Searching the cache 140 may therefore yield not only the flight as a part of a possible interline offer but also at least some of the rules for determining the price of the flight.

FIG. 4B depicts an example of a user interface 400 associated with the rules engine 130, in accordance with some example embodiments. Referring to FIG. 4B, the user interface 400 may be used to configure one or more rules for constructing an itinerary including, for example, pricing rules, routing rules, and fare construction rules. For example, the user interface 400 shown in FIG. 4B includes rules to forbid (e.g., DENY) connections through certain intermediary airports. Referring again to FIG. 2B, applying such fare construction rules to the traversal of the graph 250 may include applying the fare construction rules as filters at the nodes corresponding to the forbidden intermediary airports to eliminate the candidate itineraries that contain these nodes. As shown in FIG. 4B, the user interface 400 may also include rules associated with the enablement of through-checked baggage and pricing rules. For instance, the example of the pricing rule shown in FIG. 4B may include a special pricing that is applied to an itinerary that includes certain intermediary stops. Such a pricing rule may be applied as part of dynamic pricing workflow to derive flexible and real time pricing to the itineraries that are returned as the results of a shopping request.

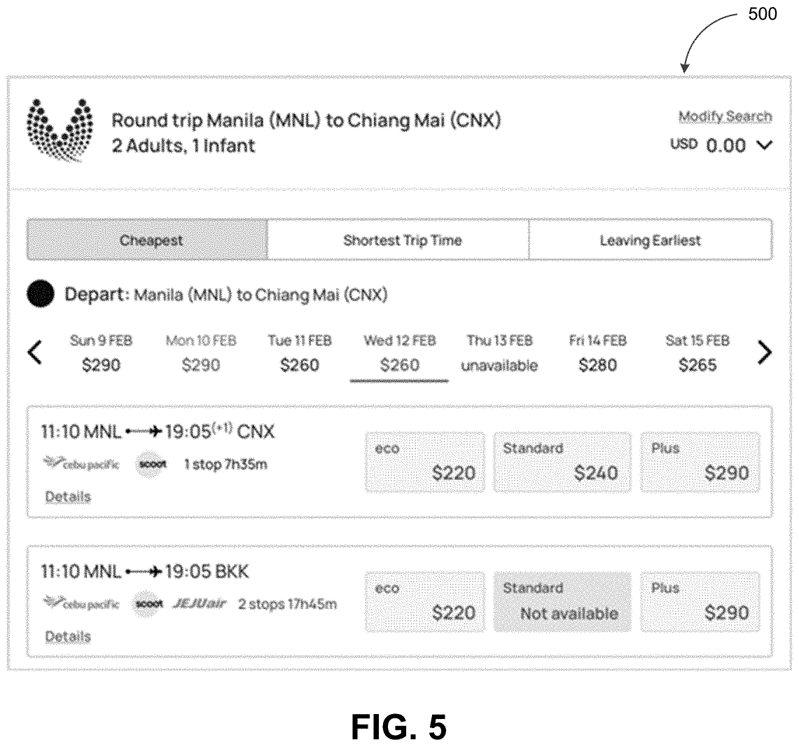

In some example embodiments, the interline controller 110 may be configured to provide the results of a shopping request in a variety of manners. For example, the interline controller 110 may provide, to the client device 120 for display as part of the website and/or the mobile application, the offers responsive to shopping request ranked according to one or more criteria including, for example, price (e.g., from least to most expensive or vice versa), travel time (e.g., from shortest travel time to longest travel time or vice versa), departure date (e.g., from earliest departure date to latest departure date or vice versa), and/or the like. FIG. 5 depicts an example of a user interface 500 providing a variety of options for ranking and displaying the results of shopping request.

In some example embodiments, the behavior of the virtual passenger service system 100 may be governed by a set of workbooks, each of which defining at least some of the logic for handling certain events such as a shopping request or a booking request for interline offers. The workbook architecture may be hierarchical, with the set of workbooks being recursively usable abstractions that govern successive layers of behavior at the virtual passenger service system 100. A workbook may be a data object including a set of instructions that are executed by the virtual passenger service system 100, for example, the interline controller 110, in response to an event such as a shopping request or a booking request. In some cases, different events may be associated with different workbooks. Moreover, workbooks associated with the virtual passenger service system 100 may be embedded data objects in which a first data object corresponding to a first workbook is nested within a second data object corresponding to a second workbook such that executing the instructions included in the second workbook may cause the execution of at least a portion of the instructions included in the first workbook. As such, a workbook may provide a high-level logic implemented at the virtual passenger service system 100 in response to an event (e.g., a shopping request, a booking request, and/or the like). Executing this high-level logic may trigger additional workbooks providing vendor-specific logic called playbooks.

The virtual passenger service system 100 is an event-driven system, with events emanating from various external systems that feed context and status information to the virtual passenger service system 100 such as external calls requesting services, information vendor systems, and/or the like. The virtual passenger service system 100 may define logic for responding to such events with general, high-level logic being encapsulated in workbooks that in turn invoke vendor-specific logic encapsulated in various playbooks. Conceptually, a workbook may thus serve as an overarching event handler that is independent of any particular vendor. Nevertheless, depending on the context (e.g., an event such as a shopping request), the workbook may respond to events by invoking vendor specific rules to accomplish its goals. A workbook is a hierarchical logical structure that may contain other workbooks including vendor playbooks, which are logical structures encapsulating how the virtual passenger service system 100 interacts with specific vendor passenger service systems. A playbook may thus expose a level of coherent vendor-specific behavior which can be accessed from within the workbook. The specific vendor application programming interface (API) calls that may be relevant to the virtual passenger service system 100 may be encapsulated by the vendor gateway 150.

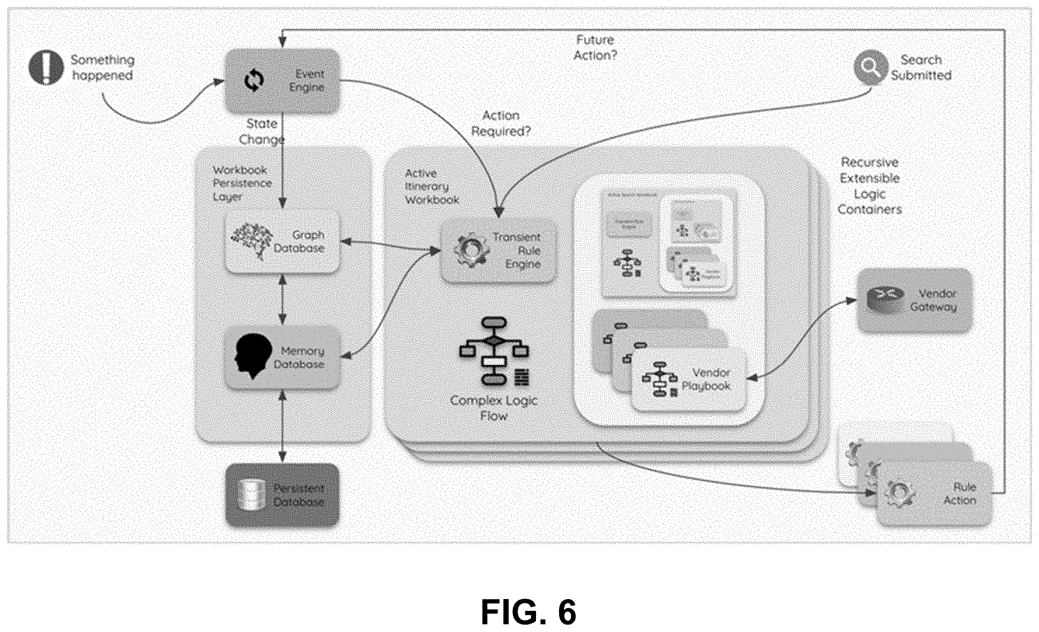

This relationship is shown in FIG. 6, which depicts a schematic diagram illustrating the aforementioned event-driven workbook structure interacting with vendor-specific playbooks to realize various bespoke event-handling logic. As one example, the virtual passenger service system 100 may respond to an event including the partial cancellation of an existing itinerary. The interline controller 110 may respond to this event by initiating a “Chargeback Workbook” with the specific itinerary as its context and with details of a desired outcome. Executing the logic included in the “Chargeback Workbook” may include identifying one or more vendors affected by the partial cancellation, locating the corresponding the vendor specific playbooks, and executing the logic included in the playbooks to handle the chargeback action per the behavior specified by each vendor.

As noted, this hierarchical architecture modularizes otherwise complex behavior across multiple vendors, thus supporting an infinitely scalable interlining paradigm capable of accommodating vendor-specific logic imposed by any number of vendors. The behavior of any individual vendor may be altered without necessitating a software release cycle. Moreover, workbook execution may be asynchronous such that the vendor-specific logic included in each playbook may be executed in parallel to maximize computational speed and efficiency. Each abstraction layer of behavior execution (e.g., workbook, playbook, and/or the like) may be defined as an object-oriented class within the virtual passenger service system 100, and thus represent the root of behavior definition. The narrower scoped behavior may inherit behavior from a higher scope behavior, with the option to override at least some of the higher scope behavior to better represent the narrower scope behavior. This way of defining behavior makes it possible to capture arbitrarily complex behavior models and represent them as a set of collaborating object definitions that encapsulate behavior in a manner that promotes separation of concerns.

In some example embodiments, the virtual passenger service system 100 may also be rendered in a cloud-native implementation that is also cloud-agnostic such that it is compatible with any cloud provider. As such, the virtual passenger service system 100 may operate globally at a cloud-scale, without having any specific dependency on any particular cloud provider. The highly scalable nature of the cloud-native architecture lends significant flexibility to the throughput of the virtual passenger service system 100. For example, multiple tasks may be performed in parallel without a need to queue tasks or for batched, off-hour processing. The virtual passenger service system 100 is therefore able to handle large quantities of interline itineraries, each of which being a collection of services and/or products from multiple vendors encapsulated within a Super Passenger Name Record (PNR). The actions that the virtual passenger service system 100, for example, the interline controller 110, takes to service one Super Passenger Name Record (PNR) may be independent of other interline itineraries (and the corresponding Super Passenger Name Records).

Computational speed and efficiency may be maximized by implementing parallelism wherever possible. For example, the virtual passenger service system 100 may perform tasks to service multiple processes, such as bookings, in parallel. The virtual passenger service system 100 may be multi-threaded, meaning that the virtual passenger service system 100 may handle multiple simultaneous requests by running multiple corresponding threads, each invoking logic that the interline controller 110 executes in parallel with the appropriate task-specific context. Even when some tasks associated with any particular interline itinerary may performed in sequence (e.g., on a first-in-first-out (FIFO) basis), other tasks associated with the same interline itinerary and tasks associated with other interline itineraries may still be executed in parallel.

Allocation of cloud-resources may be dynamic and load based. For example, depending on the level of activity at the virtual passenger service system 100, the cloud-native foundation may allocate new container pods (e.g., of cloud computational resources such as central processor units (CPUs), memory, storage, network bandwidth, and/or the like) to handle spikes in demand. Spare container pods may be shut down when the demand at the virtual passenger service system 100 wanes. Because the virtual passenger service system 100 is implemented without any physical computational resources such as data centers and serves, the computational resources required to handle peak loads may be made available dynamically, allowing the virtual passenger service system 100 to parallelize as many tasks as necessary.

To support the air travel domain, the high-level behavior of the virtual passenger service system 100 may be captured by a corresponding application programming interface such as the New Distribution Capability (NDC) application programming interface (API). The action language associated with the New Distribution Capability (NDC) application programming interface (API) may be permitted into the different layers of abstraction such as the workbooks and/or playbooks occupying each layer of the abstraction hierarchy. As such, each layer may be able to respond to standard New Distribution Capability (NDC) based requests such as Air Shopping, Air Service List, See Availability, Offer Price, Order Create, Order Retrieve, Manage My Booking (MMB) Service List, Manage My Booking (MMB), See Availability, Check-In Passenger, Change Ancillary, and/or the like. These common interfaces may allow different objects, such as the playbooks associated with different vendors, to exchange information and be managed synchronously by system defined behavior (e.g., carrier constructed rules and/or like).

In some example embodiments, the behavior of the virtual passenger service system 100 may exhibit frequent and often subtle variations. For example, vendor-specific system behavior may be modified by data-driven, context-sensitive rules to result in subtle variations in the results of executing the same set of workbooks and/or playbooks. As such, the interline controller 110 may maintain an audit trail memorializing the various behavior of the virtual passenger service system 100 executing the logic defined in various workbooks and/or playbooks. This audit trail may be persisted in a fast, in-memory data structure (and/or in disk storage as the data ages and/or is subject to less frequent access) and may serve as a mechanism for ensuring the accuracy and consistency of system behavior. In addition, the data included in the audit trail may be used to train various machine learning models, such as the neural network 300 used to generate dynamic pricing for various interline itineraries.

In the context of travel, the audit trail generated within the virtual passenger service system 100 may be called “travel data.” As used herein, the term may refer to a set of data associated with a particular invocation of the system behavior driven, for example, by an event such as a shopping request or a booking request. The level of granularity of this travel data may be the narrowest scope at which the executed behavior occurred. One example of travel data may memorialize the behavior of the virtual passenger service system 100 in response to a shopping request. The granularity of the travel data in this example may be at the playbook level and thus include the vendor-specific rules used to refine the initial results retrieved from the cache 140 by the interline controller 110.

In some example embodiments, travel data may be holistic in that each set of travel data may encompass, at a high level of granularity, various portions of a travel cycle including, for example, flight segments, hotel accommodations, surface transport reservations, car hire, and/or the like. For each product and/or service provided by a vendor, such as a journey, segment, or leg operated by an airline, the corresponding travel data may describe the travel cycle in its entirety. Once a particular interline itinerary is booked, the corresponding travel data may be maintained in “state” during the travel cycle. The travel data may be subject to synchronous updates and real time management to accommodate various changes to the interline itinerary necessitated by, for example, schedule disruptions (e.g., one or more Irregular Operations (IROPS)), servicing, customer-initiated actions, and/or the like.

It should be appreciated that like audit trail may also be configured to be scalable. For example, as the vendor list expands to incorporate other types of travel vendors beyond airlines, the behavior abstraction layers may also expand to accommodate, for example, ancillary providers such as car rental agencies, hotels, vacation rentals, and/or the like. As the behavior model expands, the audit trail and the solution response scope will also change, creating additional travel data.

Referring again to the shopping request example, the interline controller 110 may, upon receiving the shopping request at the virtual passenger service system 100, execute the high-level logic included in the corresponding workbook to search the cache 140. The high-level logic may further require the interline controller 110 to identify the various vendors (e.g., airlines) included in the results of searching the cache 140. For each identified vendor, the vendor-specific logic included in a corresponding playbook may be executed to validate and refine the initial results from the cache 140. Here, the execution vendor-specific logic may be done in parallel, with each vendor imposing its own data-driven, context-specific rules to govern the validation and refinement of the initial results from the cache 140. Applying these rules not only modify the behavior of the virtual passenger service system 100 but also the ultimate response provided by the interline controller 110 in response to the shopping request. Each airline may also have further subdivisions in this workbook hierarchy that impose additional levels of customization to how the virtual passenger service system 100 behaves in response to the shopping request.

This hierarchical architecture, with extensible layers of abstraction that recursively compute the result of a shopping request in parallel (e.g., simultaneously), may maximize computational speed and efficiency at the virtual passenger service system 100. Furthermore, this hierarchical architecture may afford infinite scalability to the virtual passenger service system 100 at least because complex behavior across any number of vendors are modularized. Deployed as a cloud-native software as a service (SaaS) that is also cloud provider agnostic, the virtual passenger service system 100 may in fact be infinitely scalable to accommodate any number of vendors as well as any volume of requests for interline itineraries.

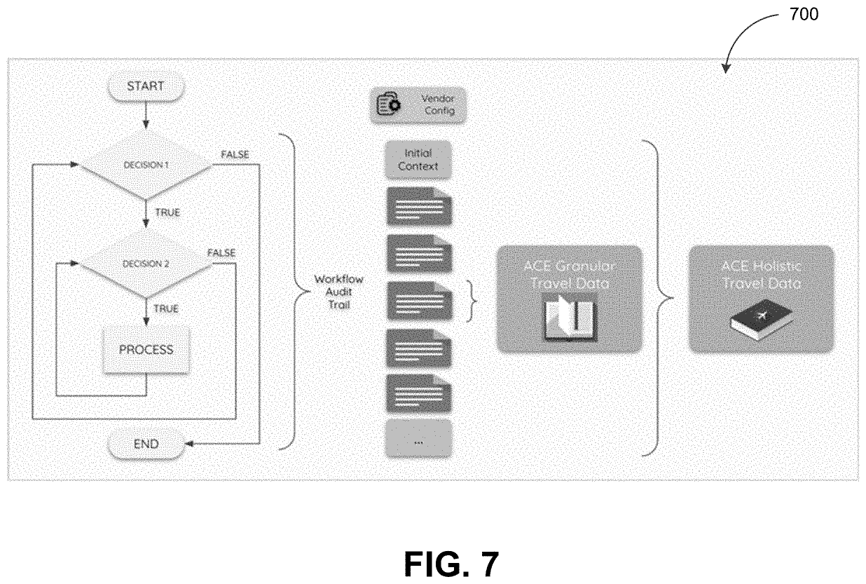

As noted, travel data may be holistic in that each set of travel data may encompass, at a high level of granularity, various portions of a travel cycle including, for example, flight segments, hotel accommodations, surface transport reservations, car hire, and/or the like. In the case of booking a particular interline itinerary, for example, the travel data associated with the ordering process may include data associated with the entire booking workflow. Holistic travel data may be the result of the interline controller 110 keep track of all the operations and decisions made as part of a workflow executed in response to an event such as a shopping request. The availability of this travel data makes it possible for subsequent validation of the behavior of the interline controller 110 and the nuances of the corresponding logic. It should be appreciated that travel data may include the various decisions that are made as part of executing the workflow as well as the actions taken in response to these decisions. The travel data may further include the context and rules driving each decision in the workflow as well as the calls (e.g., the Application Programming Interface (API) calls) that are made through the vendor gateway to trigger the actions. For these latter calls to remote vendor passenger service systems, the travel data may include the corresponding call parameters as well as data associated with the responses received from the vendor passenger service systems. To further illustrate, FIG. 7 depicts a schematic diagram illustrating an example of a process 1700 for generating travel data, in accordance with some example embodiments.

While an audit trail associated with an event such as a shopping request or a booking request may be called travel data (or holistic travel data), the audit trail for a single operation within a particular workflow may be referred to as granular travel data. Each piece of granular data may provide some insight on what the virtual passenger service system 100 did, which external system the virtual passenger service system 100 interacted with, the responses associated with these interactions, user decisions made in response to the interline offers provided by the virtual passenger service system 100, and/or the like. It should be appreciated that the virtual passenger service system 100 may provide access to this granular travel data in addition to holistic travel data.

Maintaining, in the form of holistic travel data and granular travel data, an audit trail for various iterations of workflows executed at the virtual passenger service system 100 may enable partial modifications of interline itineraries. For example, travel data may be stored, by the virtual passenger service system 100, in a stateful manner and organized for efficient retrieval (e.g., sorted by date and time). When a change is required, all aspects of a customer's itinerary may be analyzed for coherence, using the customer's original search parameters as a guide, and adjusted if necessary. For example, the products and/or services included in the interline itinerary (e.g., flights, baggage, hotels, car rental, and/or the like) may be modified with dynamic repricing to unwind the itinerary from the end of the workflow to the point of the change. Alternatively and/or additionally, the interline itinerary may be recomputed from the point of change to generate modified interline itinerary satisfying one or more parameters such as price and travel date. If the modified itinerary is accepted, the interline controller 110 may create new charges (or refunds) based on the changes and book the corresponding products and/or services. These charges and bookings may be accomplished through the vendor gateway 150.

The rewinding, undoing, and/or replaying of a interline itinerary, especially to implement partial changes to the interline itinerary without canceling and rebooking the interline itinerary in its entirety, is made possible by the virtual passenger service system 100 maintaining a corresponding audit trail. The logic associated with the interline itinerary may be rerun with one or more modified parameters, which in turn may alter the behavior of the virtual passenger service system 100 executing the workflow.

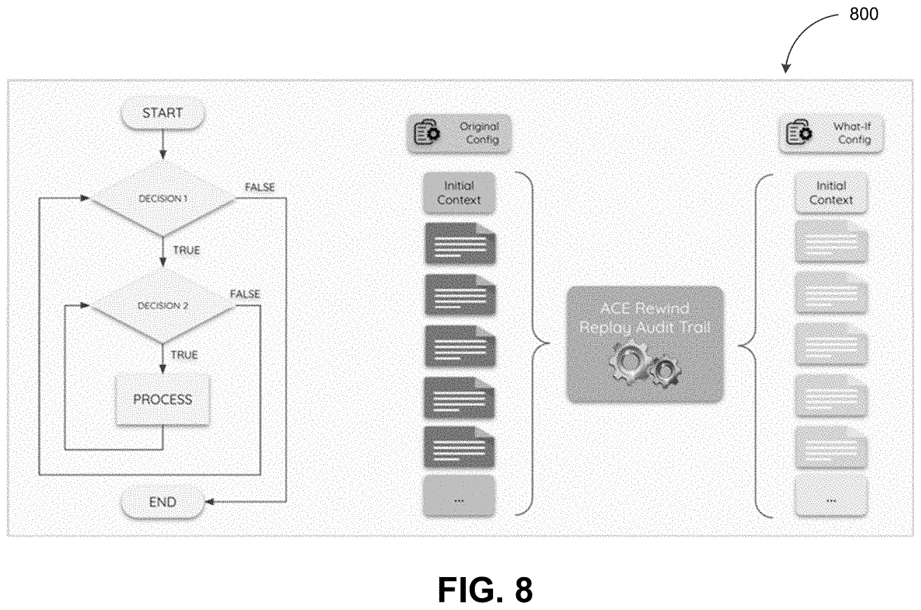

Because the virtual passenger service system 100 maintains an audit trail of workflows that had been executed at the virtual passenger service system 100 including the corresponding input parameters, it may be possible to examine the audit trail of any workflow executed in the past, rewind the workflow, and replay the workflow forward again with modified configurations. This Rewind-Replay feature may generate an output that may be compared against the output of the originally executed workflow to perform a “what-if” analysis of various configurations. Such analysis may be especially helpful to test changes to the logic executed at the virtual passenger service systems 100 including more granular changes to vendor-specific logic executed to price interline itineraries. FIG. 8 depicts a schematic diagram illustrating an example of a rewind-replay process 800 for running “what-if” scenarios against past decisions to validate proposed logic modifications.

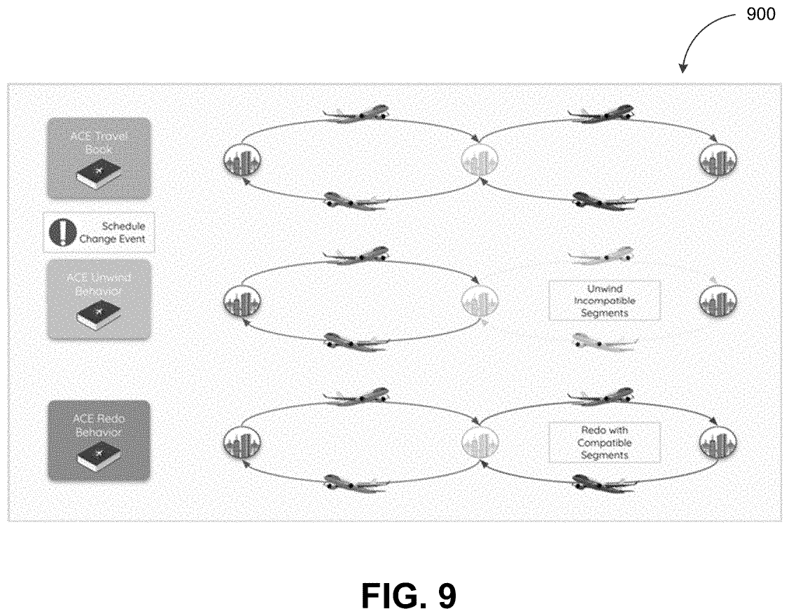

Alternatively and/or additionally, the virtual passenger service system 100 may provide an Unwind-Replay in which the results of a workflow executed at the virtual passenger service system 100 may be unwound step by step up to a particular point in the past. The Unwind-Replay feature may be used to effect a partial change to an interline itinerary, for example, in response to a schedule disruption (e.g., one or more Irregular Operations (IROPS)) or a customer-initiated action. For example, if an interline itinerary includes a canceled or a rescheduled flight that no longer satisfy the Minimum Connection Time (MCT) requirement associated with the interline itinerary, the workflow to book the interline itinerary may be unwound to the point of the canceled or rescheduled flight. Playing the workflow forward from that point may include providing additional interline offers for completing the remainder of the journey that satisfy the original parameters of the interline itinerary. To further illustrate, FIG. 9 depicts a schematic diagram illustrating an example of an unwind-replay process 900, in accordance with some example embodiments.

As noted, in some example embodiments, the virtual passenger service system 100 may be configured to operate in accordance to a New Distribution Capability (NDC) standard. Accordingly, when constructing an interline offer including products and services from multiple vendors, the virtual passenger service system 100 may construct an New Distribution Capability (NDC) Offer that includes one or more offer items. An offer item may include journeys, which in turn may include segments formed by one or more legs. Offer items can have journeys and journeys and have segments, and segments can have legs. Various implementations of the current subject matter enhances the existing NDC schema through the holistic travel data architecture to enable the construction of a travel cycle having any number of different legs, segments, and journeys, in any order. This travel cycle may be converted to the NDC schema format to form an overall interline offer with multiple individual parts. In effect, the virtual passenger service system 100 operates to automatically create an interlining structure within the NDC scope.

One challenge associated with generating interline offers arise when attempting to combine services provided by full-service carriers (FSC) and low-cost carriers (LCC). Whereas the full-service carriers will have scheduled services to a main hub, the vast majority of low-cost carriers tend to provide the last leg of journeys from the hub to a regional destination. There may be multiple low-cost carriers that offer flights between a regional destination and a main hub operated by a full-cost carrier. An interline itinerary between two regional destination may therefore include flights operated by full-cost carriers and/or low-cost carriers.

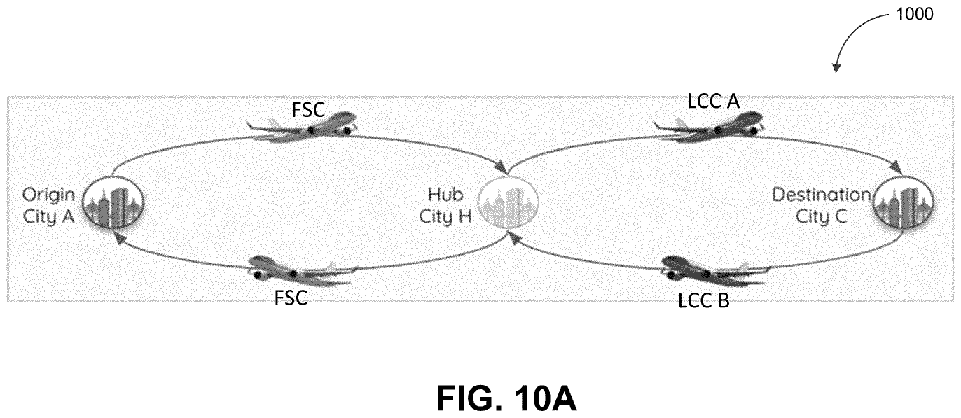

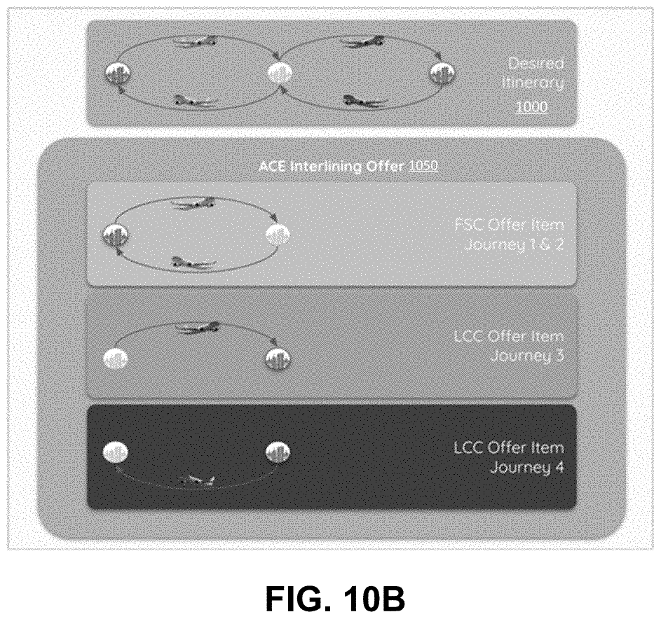

FIG. 10A depicts an example of an interline itinerary 1000, in accordance with some example embodiments. As shown in FIG. 10A, the interline itinerary 1000 may include round trip fare on a full service carrier (FSC) between Original City A and Hub City H, one way fare from the Hub City H to Destination City C on a first low cost carrier LCC A, and one way fare from the Destination City C to the Hub City H on a second low cost carrier LCC B. The interline itinerary 1000 may include one or more constituent NDC offer items, which are shown in FIG. 10B to form a corresponding NDC interline offer 1050. Table 1 below includes a representation of the NDC interline offer 1050 in an NDC format.

TABLE 1

```
  ● Offers
    ○ Offer - $1200
      ▪ Offer ID
      ▪ Offer Item 1
        ● Offer Item ID
        ● Fare $400
        ● Journey 1 (Round trip on Airline Blue A->H)
          ○ Segment 1 (A->H)
        ● Journey 2 (Round trip on Airline Blue H->A)
          ○ Segment 1 (H->A)
      ▪ Offer Item 2
        ● Offer Item ID
        ● Fare $500
        ● Journey 3 (One way on Airline Red H->C)
          ○ Segment 1 (H->C)
      ▪ Offer Item 3
        ● Offer Item ID
        ● Fare $300
        ● Journey 4 (One way on Airline Green C->H)
Segment 1 (C->H)
```

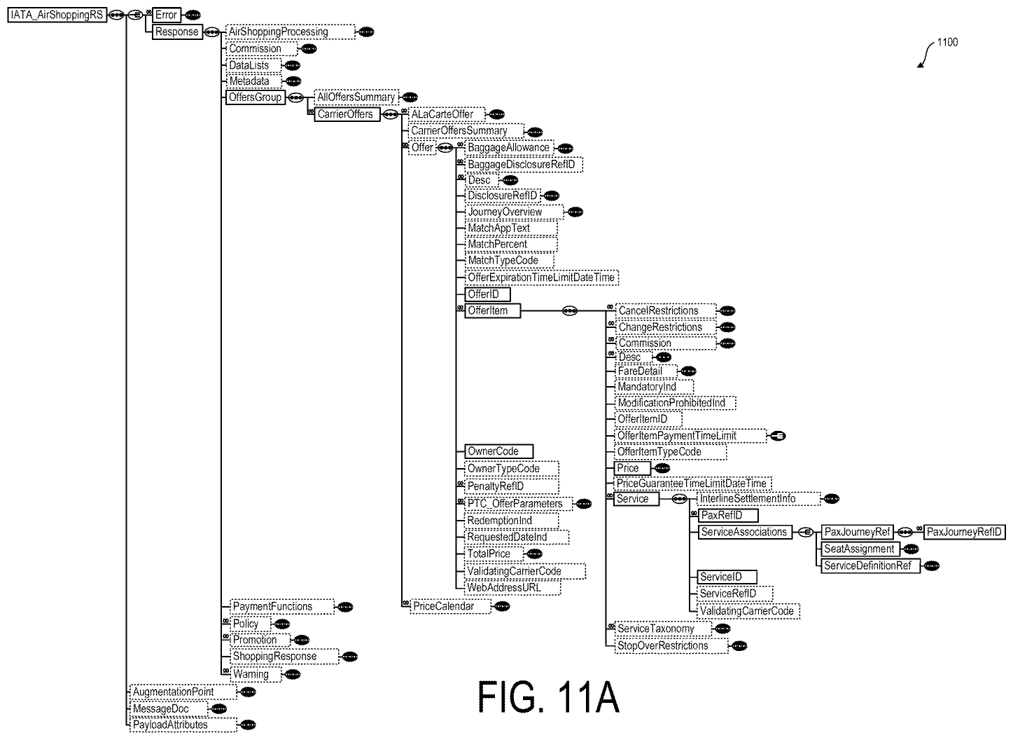

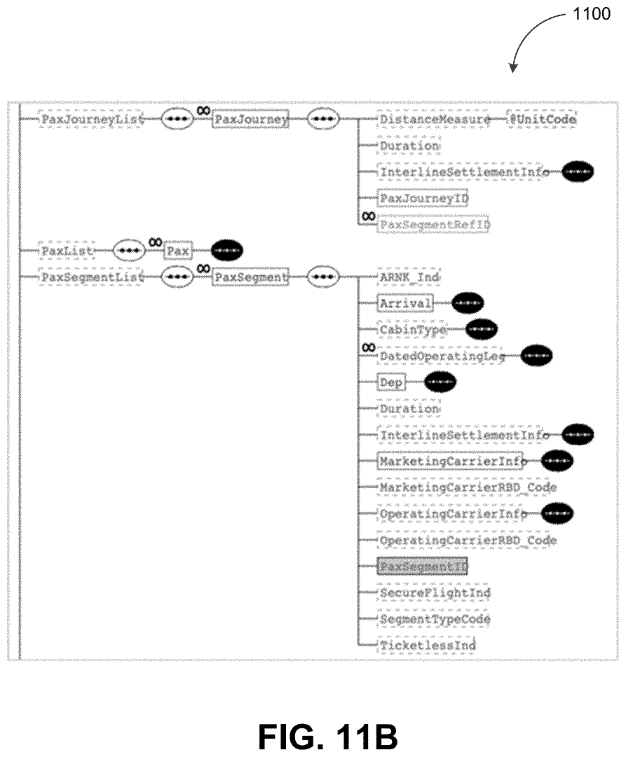

FIG. 11A depicts an example of a response 1100 to a shopping request that includes multiple NDC offers, each of which including one or more offer items. A zoomed in portion of the response 1100 is shown in FIG. 11B to further illustrate the segment details included in the response 1100. Various implementations of the current subject matter make it possible to break up a complex interline itinerary into a set of separate offer items within a larger offer context, with each offer item corresponding to a segment of a journey.

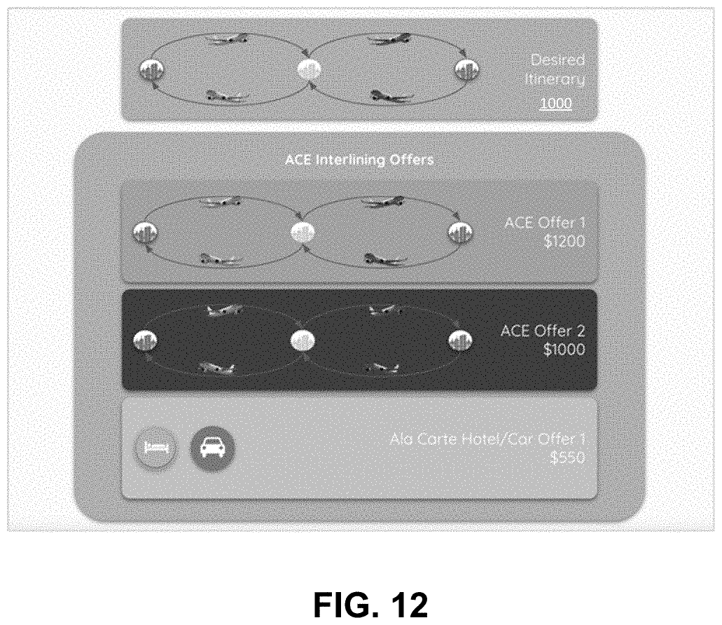

In some example embodiments, the same New Distribution Capability (NDC) paradigm may extended to construct multiple offers, each of which including an interline itinerary with products and/or services from different vendors. It should be appreciated that each offer may be constructed based vendor-specific pricing, routing, and fare construction rules. An example of this is shown in Table 2, which shows the second NDC offer item of the second NDC offer being optimized with dynamic pricing. Moreover, each offer may be associated with a unique routing and fare construct determined based on a current inventory status for the date of travel. At least some offers may include non-air travel products and/or services. FIG. 12 shows that multiple NDC offers may be generated to correspond to the same interline itinerary 1000. As shown in FIG. 12, such offers may be presented as a la carte offer item in the NDC offer.

```
TABLE 2
● Offers
  ○ Offer - $1200
    ▪ Offer ID
    ▪ Offer Item 1
      ● Offer Item ID
      ● Fare $400
      ● Journey 1 (Round trip on Airline Blue A->H)
        ○ Segment 1 (A->H)
      ● Journey 2 (Round trip on Airline Blue H->A)
        ○ Segment 1 (H->A)
    ▪ Offer Item 2
      ● Offer Item ID
      ● Fare $500
      ● Journey 3 (One way on Airline Red H->C)
        ○ Segment 1 (H->C)
    ▪ Offer Item 3
      ● Offer Item ID
      ● Fare $300
      ● Journey 4 (One way on Airline Green C->H)
        ○ Segment 1 (C->H)
  ○ Offer - $1000
    ▪ Offer ID
    ▪ Offer Item 1
      ● Offer Item ID
      ● Fare - $400
      ● Journey 1 (Round trip on Airline Blue A->H)
        ○ Segment 1 (A->H)
      ● Journey 2 (Round trip on Airline Blue H->A)
        ○ Segment 1 (H->A)
    ▪ Offer Item 2
      ● Offer Item ID
      ● Fare Dynamic pricing of this segment, (discount $800 to $600)
      ● Journey 3 (One way on Airline Red H->C) $500
        ○ Segment 1 (H->C)
      ● Journey 4 (One way on Airline Green C->H) $300
          Segment 1 (C->H)
```

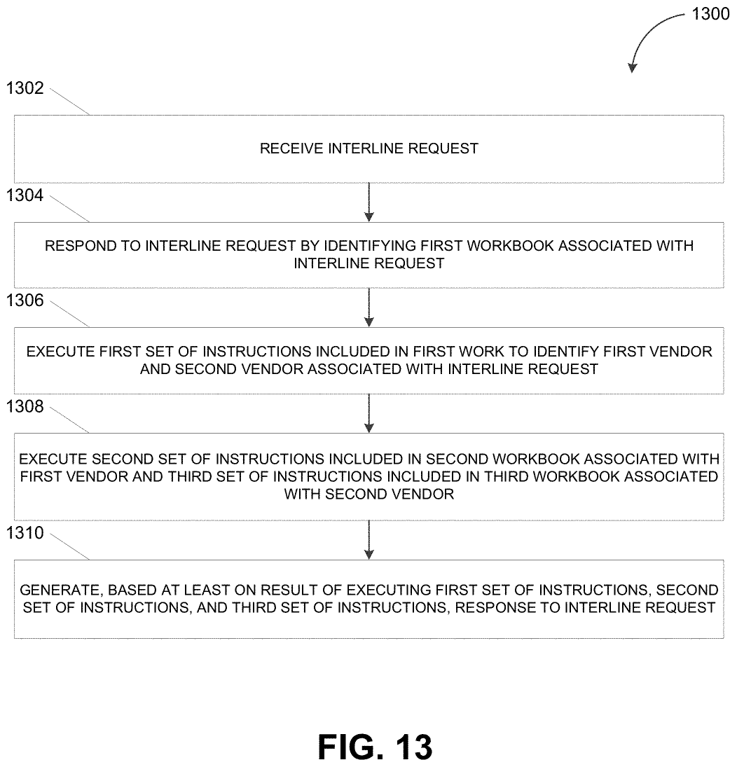

FIG. 13 depicts a flowchart illustrating an example of a process 1300 for processing an interline request, in accordance with some example embodiments. Referring to FIGS. 1-13, the process 1300 may be performed by the interline controller 110 to respond to an interline request, such as a shopping request, a booking request, and/or the like, received at the virtual passenger service system 100.

At 1302, the interline controller 110 may receive an interline request. In some example embodiments, the interline controller 110 may receive, from the client device 120, an interline request such as a shopping request, a booking request, and/or the like. Referring to FIGS. 1A, the client device 120 may be associated with a first vendor (e.g., a first airline) having an interline relationship with one or more other vendors to allow the first vendor to sell interline itineraries that bundle products and services from multiple vendors including, for example, the first vendor, a second vendor (e.g., a second airline), and/or the like. Customers of the first vendor may send the interline request through a booking engine of the first vendor associated with the client device 120, for example, via a website, a mobile application, and/or the like. In other words, the presence of the virtual passenger service system 100 may be transparent to these customers. Nevertheless, the virtual passenger service system 100, through its interface with the client device 120 (e.g., an Application Programming Interface (API), the client side software development kit (SDK) 125, and/or the like), may provide to these customers interline itineraries that includes products and services from other vendors the virtual passenger service system 100 interfaces with, for example, through the vendor gateway 150.

At 1304, the interline controller 110 may respond to the interline request by identifying a first workbook associated with the interline request. In some example embodiments, the receipt of the interline request at the virtual passenger service system 100 may be an event that triggers the execution of a workbook associated with the interline request. The workbook may be a data object containing a set of instructions, also called “logic” herein, that are executed by the interline controller 110 to handle the interline request. Different events may be associated with different workbooks. As such, the interline controller 110 may execute a first workbook in response to receiving a shopping request and a second workbook in response to receiving a booking request.

At 1306, the interline controller 110 may execute a first set of instructions included in the first workbook to identify a first vendor and a second vendor associated with the interline request. In some example embodiments, the interline request may be associated with an interline itinerary. For example, a shopping request may trigger a search of the cache 140 to construct one or more interline itineraries as offers while a booking request may require the booking of the products and/or services included in a particular interline itinerary. As noted, the interline controller 110 may respond to the interline request by executing a corresponding workbook that includes additional workbooks embedded therein. As part of executing the workbook associated with the interline request, the interline controller 110 may encounter logic that requires the execution of the workbooks associated with the individual vendors providing the products and/or services included in the interline itinerary associated with the interline request. For instance, to handle an interline itinerary that includes products and/or services from the first vendor and the seconds vendor, the interline controller 110 may identify the first vendor and the second vendor in order to execute the respective vendor specific workbooks, or playbooks, associated with these vendors.

At 1308, the interline controller 110 may execute a second logic included in a second workbook associated with the first vendor and a third logic included in a third workbook associated with the third vendor. For example, the interline controller 110 may execute a first playbook associated with the first vendor and a second playbook associated with the second vendor. Doing so may apply vendor-specific logic to the handling of the interline request. Some vendor-specific logic may include interactions with the passenger service system (PSS) of the first vendor and/or the second vendor. Such vendor-specific logic may require invoking, at the vendor gateway 150, one or more corresponding application programming interface (API) calls. In the case of a booking request, for example, the interline controller 110 may also interact, through the vendor gateway 150, with a payment gateway in order to process one or more payments associated with the interline itinerary. Other examples of vendor-specific logic may include pricing rules, routing rules, and fare construction rules that may be applied, for example, at the virtual passenger service system 110 to ensure that the interline itinerary is consistent with the requirements of the first vendor and the second vendor.

At 1310, the interline controller 110 may generate, based at least on a result on executing the first logic, the second logic, and the third logic, a response to the interline request. For example, as a response to a shopping request, the interline controller 110 may construct one or more interline itineraries as offers. Alternatively and/or additionally, as a response to a booking request to purchase a interline itinerary, the interline controller 110 may generate a confirmation including a Super Passenger Name Record (PNR) associated with the interline itinerary. The construction of interline offers and the booking of an interline itinerary may be performed by executing the corresponding hierarchy of workbooks and/or playbooks.

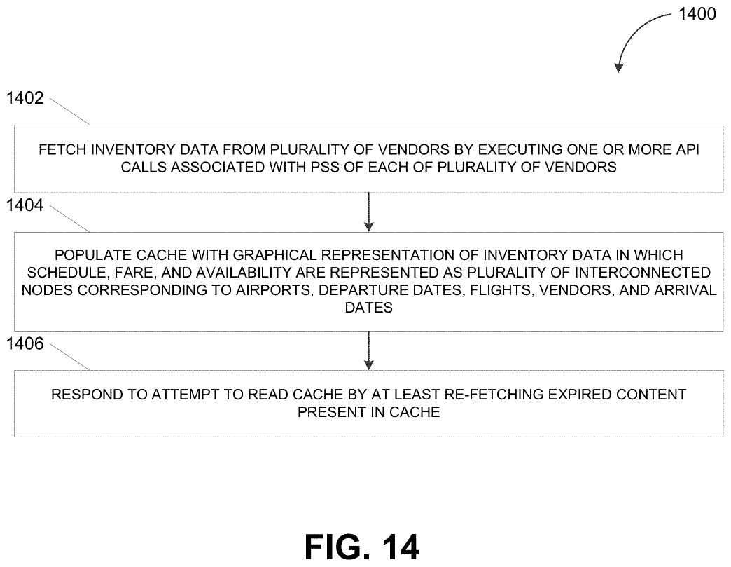

FIG. 14 depicts a flowchart illustrating an example of a process 1400 for graph-based inventory management, in accordance with some example embodiments. Referring to FIGS. 1-12 and 14, the process 1400 may be performed by the interline controller 110 to maintain the cache 140, which may be an in-memory, graph-based database storing a combined schedule, fare, and availability inventory from multiple vendors.

At 1402, the interline controller 110 may aggregate inventory data from a plurality of vendors by executing one or more application programming interface (API) calls associated with a passenger service system of each of the plurality of vendors. In some example embodiments, while the logic that triggers interactions with the passenger service system of one or more vendors may be encapsulated in workbooks and/or playbooks at the virtual passenger service system 100, the vendor gateway 150 may provide the application programming interfaces (APIs) capable of interfacing with these external passenger service systems. One example of an interaction with a vendor's passenger service system (PSS), such as the passenger service system of an airline, is to fetch inventory data. As shown in FIG. 1A, the vendor gateway 150 may provide an application programming interface for multiple vendors, thereby enabling the fetching of inventory data from multiple vendors including providers of ancillary products and services such as hotel accommodations, car rentals, cruises, and attractions and entertainment.

At 1404, the interline controller 110 may populate the cache 140 with a graphical representation of the inventory data in which schedule, fare, and availability are represented as a plurality of interconnected nodes corresponding to airports, departure dates, vendor, and arrival dates. In some example embodiments, the cache 140 may be implemented as a graph-based, in-memory database in order to maximize search speed and efficiency. As shown in FIG. 2A, the cache 140 may include the graph 200 with a collection of nodes, each of which corresponding to an airport, a departure date, an airline, and an arrival date. For example, the graph 200 may include a first node corresponding to a flight, a second node corresponding to a vendor, a third node corresponding to a first airport (Airport A), a fourth node corresponding to a second airport (Airport B), a fifth node corresponding to a departure date, and a sixth node corresponding to an arrival date.

One or more connections between the nodes may indicate a relationship such as, for example, “operated by,” “departing from,” “arriving at,” “departing on,” “arriving on,” and/or the like. As such, the interconnected nodes included in the graph 200 may indicate that the flight corresponding to the first node being operated by the vendor corresponding to the second node and departing on the departure date corresponding to the fifth node from the first airport corresponding to the third node to arrive at the second airport corresponding to the fourth node on the arrival date corresponding to the sixth node. In addition, the graph 200 may include additional nodes corresponding to various rules such as, for example, pricing rules, routing rules, fare construction rules, and/or the like. For instance, the first node corresponding to the flight may be further connected to one or more additional nodes, each of which corresponding to at least one of the rules for determining the price of the flight (e.g., price increase, price decrease, minimum price, maximum price, and/or the like).

At 1406, the interline controller 110 may respond to an attempt to read the cache 140 by at least re-fetching expired content present in the cache 140. In some example embodiments, data decay may be minimized by the interline controller 110 refreshing the cache 140 on a demand-driven basis. Refreshing the cache 140 may include removing and/or replacing obsolete inventory data present in the cache 140. Moreover, instead of a fixed schedule for refreshing the contents of the cache 140, the schedule for updating the contents of the cache 140 may evolve over time in response to changes in vendor practices, market conditions, and/or the like. The dynamically determined refresh schedule may thus assign, to different content (or different types of content) in the cache 140, different lengths of time (e.g., time-to-live (TTL)) during which the content is valid. Attempts the read the cache 140 may cause the expired content in the cache 140 (e.g., content with an expired time-to-live (TTL)) to be re-fetched from the corresponding vendor passenger service systems.

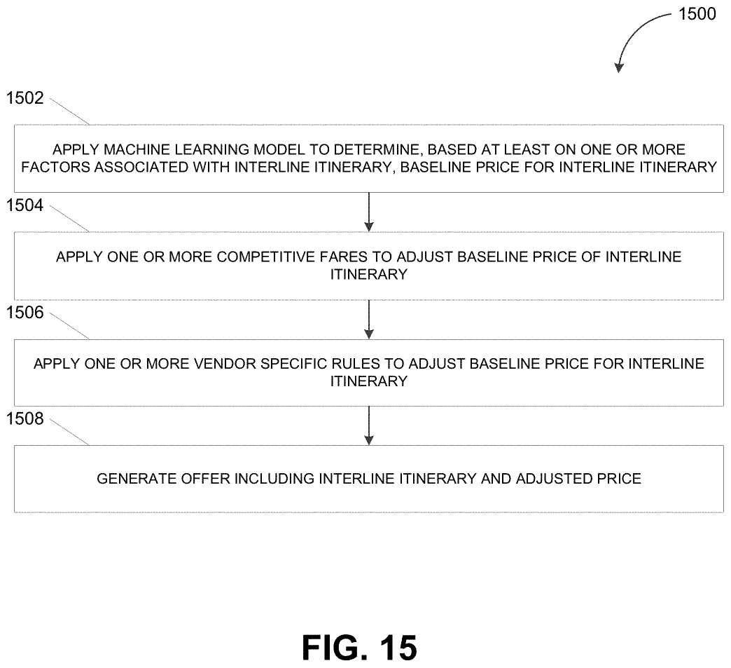

FIG. 15 depicts a flowchart illustrating an example of a process 1500 for dynamic pricing, in accordance with some example embodiments. Referring to FIGS. 1-12 and 15, the process 1500 may be performed by the interline controller 110 to determine a price for an interline itinerary that includes products and/or services provided by multiple vendors.

At 1502, the interline controller 110 may apply a machine learning model to determine, based at least on one or more factors associated with an interline itinerary, a baseline price for the interline itinerary. In some example embodiments, the interline controller 110 may respond to a shopping request by at least constructing one or more interline itineraries to provide as offers responsive to the shopping request. An interline itinerary may, as noted, contain products and/or services from multiple vendors including, for example, a first flight operated by a first airline, a second flight operated by a second airline, and/or the like. The interline itinerary may be difficult to price at least because the interline itinerary may include at least some routes that are unscheduled flights, which are not published and lack predetermined pricing.

To price the interline itinerary, the interline controller 110 may determine a baseline price by applying a machine learning model trained to determine a price for the interline itinerary based on a variety of factors associated with the interline itinerary including, for example, an origin, a destination, a date of travel, a season of travel, current conditions, market conditions, flight operation costs, theoretical price per seat, and/or the like. One example of the machine learning model is the neural network 300 shown in FIG. 3, which may be trained using popular interline itineraries encountered at the virtual passenger service system 100 at an above-threshold frequency.

At 1504, the interline controller 110 may apply one or more competitive fares to adjust the baseline price of the interline itinerary. In some example embodiments, the interline controller 110 may adjust the baseline price for the interline itinerary based on one or more competitive fares. These adjustments may be made to the fares of one or more of the flights included in the interline itinerary. The baseline price for the interline itinerary may be adjusted to ensure that the interline itinerary is not priced above (or below) comparable itineraries from the same origin to the same destination on the same travel date. Such adjustments may be made based on prevailing market fares (or fare ranges), which may be determined based on current market data obtained from a variety of sources including, for example, search engines, travel aggregators, and/or the like.

At 1506, the interline controller 110 may apply one or more vendor specific rules to adjust the baseline price for the interline itinerary. In some example embodiments, the interline controller 110 may adjust the baseline price for the interline itinerary by applying, to a flight in the interline itinerary serviced by an airline, one or more vendor specific rules associated with the airline. These vendor specific rules may specify, for example, an increment (e.g., a fraction and/or the like) for adjusting the baseline price as well as a threshold price (e.g., a minimum price, a maximum price, and/or the like). Alternatively and/or additionally, the interline controller 110 may adjust the price of the interline itinerary as a whole by providing bundled discounts for various ancillary products and/or services included in the interline itinerary. Such discounts may also be specified by one or more vendor specific rules associated with the providers of the primary products and/or services and/or the providers of the ancillary products and/or services.

At 1508, the interline controller 110 may generate an offer including the interline itinerary with the adjusted price. In some example embodiments, for each interline itinerary satisfying the parameters of the shopping request, the interline controller 110 may generate a New Distribution Capability (NDC) offer having an NDC offer item for each of the product or service included in the interline itinerary. These NDC offers, including the corresponding prices, may be provided to the customer associated with the corresponding shopping request. In the example shown in FIG. 1A, these NDC offers may be sent to the client device 120 and presented to the customer via a website and/or a mobile application the first vendor (e.g., the first airline) associated with the client device 120. Referring to the example of the user interface 500 shown in FIG. 5, the interline controller 110 may support a variety of ranking criteria such that the NDC offers responsive to the shopping request may be presented to the customer sorted based on price, travel time, departure date, and/or the like.

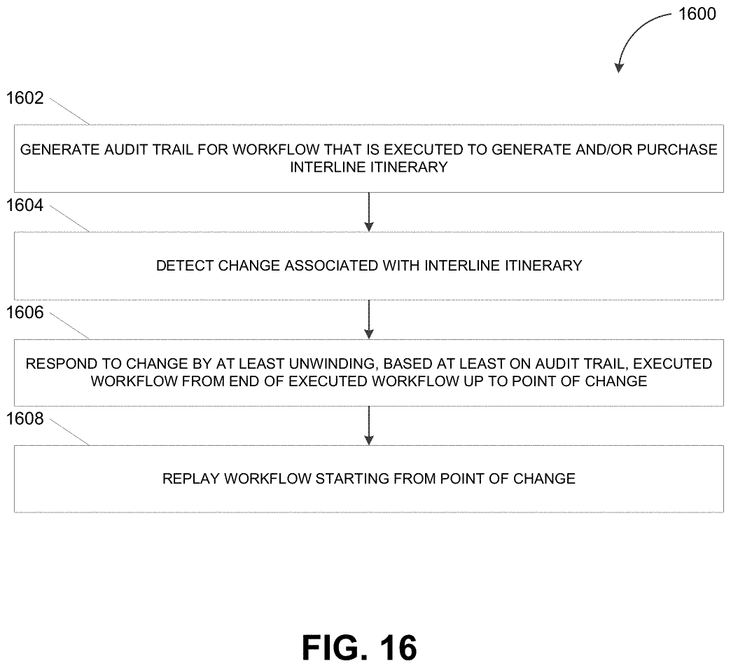

FIG. 16 depicts a flowchart illustrating an example of a process 1600 for interline order modification, in accordance with some example embodiments. Referring to FIGS. 1-12 and 16, the process 1600 may be performed by the interline controller 110 to modify a portion of an existing interline itinerary without canceling and rebooking the interline itinerary in its entirety.

At 1602, the interline controller 110 may generate an audit trail for a workflow that is executed to generate and/or purchase an interline itinerary. In some example embodiments, the interline controller 110 may maintain an audit trail memorializing the various behavior of the virtual passenger service system 100 executing, in response to an interline request such as a shopping request or booking request, a workflow corresponding to the logic defined in various workbooks and/or playbooks associated with the interline request. In the context of the virtual passenger service system 100, the audit trail may be called “travel data.” Travel data, whether holistic travel data covering an entire audit trail or granular travel data capturing discrete operations, may serve as a mechanism for ensuring the accuracy and consistency of the behavior at the virtual passenger service system 100. In some cases, this travel data may also be used to train various machine learning models, such as the neural network 300 used to generate dynamic pricing for various interline itineraries.

For a single interline itinerary generated at and/or purchased through the virtual passenger service system 100, the interline controller 110 may generate holistic travel data capturing, at a high level of granularity, various portions of a travel cycle including, for example, flight segments, hotel accommodations, surface transport reservations, car hire, and/or the like. For each product and/or service provided by a vendor, such as a journey, segment, or leg operated by an airline, the corresponding travel data may describe the travel cycle in its entirety. Once a particular interline itinerary is booked, the corresponding travel data may be maintained in “state” during the travel cycle.

As the interline controller 110 may execute a hierarchical set of logic (e.g., workbooks, playbooks, and/or the like) in order to generate and/or book an interline itinerary, holistic travel data may cover every operation performed during the execution of this logic. For example, travel data may include the various decisions that are made as part of executing the workflow as well as the actions taken in response to these decisions. The travel data may further include the context and rules driving each decision in the workflow as well as the calls (e.g., the Application Programming Interface (API) calls) that are made through the vendor gateway to trigger the actions. For these latter calls to remote vendor passenger service systems, the travel data may include the corresponding call parameters as well as data associated with the responses received from the vendor passenger service systems.

At 1604, the interline controller 110 may detect a change associated with the interline itinerary. For example, the interline controller 110 may detect a change corresponding to a schedule disruption (e.g., one or more Irregular Operations (IROPS)) or a customer-initiated action in which a flight included in an interline itinerary is canceled or changed. The result of this change may be that the interline itinerary no longer valid, for example, because the interline itinerary no longer satisfies a Minimum Connection Time (MCT) requirement associated with the interline itinerary.

At 1606, the interline controller 110 may respond to the change by at least unwinding, based at least on the audit trail, the executed workflow starting from an end of the executed workflow to a point of the change. In some example embodiments, a change in the interline itinerary that invalidates the interline itinerary may necessitate a change to the interline itinerary. However, instead of having to cancel and rebook the interline itinerary in its entirety, the interline controller 110 may apply the travel data associated with the interline itinerary to apply a partial change to the interline itinerary. This partial change may include, for example, an unwinding of the workflow executed to generate and/or book the interline itinerary starting from the end of the executed workflow up to the change (e.g., up to the canceled or rescheduled flight). The interline controller 110 may unwind the workflow associated with the interline itinerary by at least undoing the operations that were executed in the workflow starting at the point of the change.

At 1608, the interline controller 110 may replay the workflow starting from the point of the change. In some example embodiments, once the workflow associated with the interline itinerary is unwound to the point of the change, the interline controller 110 may provide the option of replaying the workflow forward from that point. Doing so may generate one or more alternative interline offers for completing the remainder of the journey while still satisfying the original parameters of the interline itinerary. However, it should be appreciated that replaying the workflow may be one option provided to the customer while another option may be to simply cancel the remainder of the interline itinerary, which is accomplished by the unwinding of the workflow associated with the interline itinerary up to the point of the change.

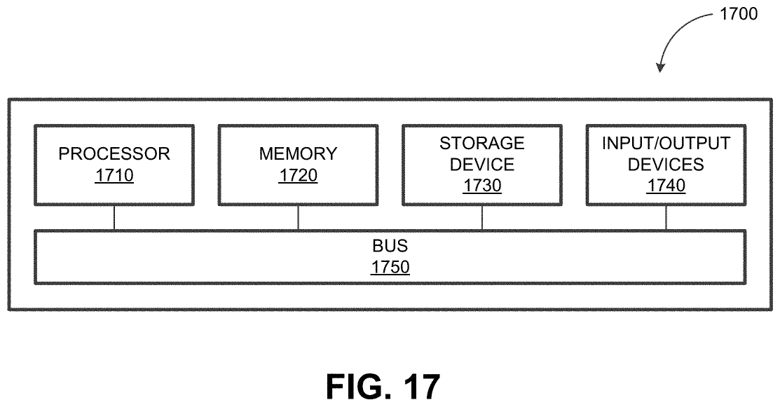

FIG. 17 depicts a block diagram illustrating a computing system 1700, in accordance with some example embodiments. Referring to FIGS. 1-17, the computing system 1700 can be used to implement the interline controller 110 and/or any components therein.

As shown in FIG. 31, the computing system 1700 can include a processor 1710, a memory 1720, a storage device 1730, and input/output devices 1740. The processor 1710, the memory 1720, the storage device 1730, and the input/output devices 1740 can be interconnected via a system bus 1750. The processor 1710 is capable of processing instructions for execution within the computing system 1700. Such executed instructions can implement one or more components of, for example, the interline controller 110 and/or the like. In some implementations of the current subject matter, the processor 1710 can be a single-threaded processor. Alternately, the processor 1710 can be a multi-threaded processor. The processor 1710 is capable of processing instructions stored in the memory 1720 and/or on the storage device 1730 to display graphical information for a user interface provided via the input/output device 1740.

The memory 1720 is a computer readable medium such as volatile or non-volatile that stores information within the computing system 1700. The memory 1720 can store data structures representing configuration object databases, for example. The storage device 1730 is capable of providing persistent storage for the computing system 1700. The storage device 1730 can be a floppy disk device, a hard disk device, an optical disk device, or a tape device, or other suitable persistent storage means. The input/output device 1740 provides input/output operations for the computing system 1700. In some implementations of the current subject matter, the input/output device 1740 includes a keyboard and/or pointing device. In various implementations, the input/output device 1740 includes a display unit for displaying graphical user interfaces.

According to some implementations of the current subject matter, the input/output device 1740 can provide input/output operations for a network device. For example, the input/output device 1740 can include Ethernet ports or other networking ports to communicate with one or more wired and/or wireless networks (e.g., a local area network (LAN), a wide area network (WAN), the Internet).

In some implementations of the current subject matter, the computing system 1700 can be used to execute various interactive computer software applications that can be used for organization, analysis and/or storage of data in various (e.g., tabular) format (e.g., Microsoft Excel®, and/or any other type of software). Alternatively, the computing system 1700 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 1740. The user interface can be generated and presented to a user by the computing system 1700 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

1. A system, comprising:
at least one processor; and
at least one memory including program code which when executed by the at least one processor provides operations comprising:
receiving an interline request associated with a first vendor and a second vendor;
responding to an interline request by at least executing a first set of instructions included in a first workbook associated with the interline request, the executing of the first set of instructions includes identifying the first vendor and the second vendor;
executing a second set of instructions included in a second workbook associated with the first vendor and a third set of instructions included in a third workbook associated with the second vendor; and
generating, based at least on a result of executing the first set of instructions, the second set of instructions, and the third set of instructions, a response for the interline request.

2. The system of claim 1, wherein the interline request comprises a shopping request to generate an interline itinerary containing a plurality of services and/or products provided by the first vendor and the second vendor.

3. The system of claim 2, wherein the response for the interline request includes a New Distribution Capability (NDC) offer with a plurality of New Distribution Capability (NDC) offer items corresponding to the plurality of services and/or products provided by the first vendor and the second vendor.

4. The system of claim 2, wherein the executing of the first set of instructions further includes searching a cache containing inventory data associated with the first vendor and the second vendor in order to generate the interline itinerary.

5. The system of claim 1, wherein the interline request comprises a booking request to purchase an interline itinerary containing a plurality of services and/or products provided by the first vendor and the second vendor.

6. The system of claim 1, wherein the executing of the first set of instructions further includes interacting with a first passenger service system (PSS) of the first vendor, a second passenger service system (PSS) of the second vendor, and a payment gateway in order to purchase the interline itinerary.

7. The system of claim 1, wherein the second workbook and the third workbook are embedded within the first workbook.

8. The system of claim 1, wherein the executing of the second set of instructions included in the second workbook further includes executing a fourth set of instructions included in a fourth workbook embedded within the second workbook.

9. The system of claim 1, wherein the executing of the first set of instructions further includes executing, based at least on the interline itinerary being associated with the first vendor and the second vendor, the second set of instructions included in the second workbook and the third set of instructions included in the third workbook but not a fourth set of instructions included in a fourth workbook associated with a third vendor.

10. The system of claim 1, further comprising:
in response to the interline request being a shopping request, executing the first set of instructions included in the first workbook; and
in response to the interline request being a booking request, executing a fourth set of instructions included in a fourth workbook.

11. The system of claim 1, wherein the executing of the second set of instructions includes applying a first rule associated with the first vendor to generate the response to the interline request, and wherein the executing of the third set of instructions includes applying a second rule associated with the second vendor to generate the response to the interline request.

12. The system of claim 11, wherein the first rule comprises a pricing rule, a routing rule, and/or a fare construction rule imposed by the first vendor, and wherein the second rule comprises a pricing rule, a routing rule, and/or a fare construction rule imposed by the second vendor.

13. The system of claim 1, wherein the executing of the second set of instructions includes making one or more calls of a first application programming interface (API) to interact with a first passenger service system (PSS) of the first vendor, and wherein the executing of the third set of instructions includes making one or more calls of a second application programming interface (API) to interact with a second passenger service system (PSS) of the second vendor.

14. The system of claim 1, wherein the interline request is received at a booking engine of the first vendor to trigger the generation and/or purchase of an interline itinerary that includes products and/or services provided by the first vendor and the second vendor.

15. A computer-implemented method, comprising:
receiving an interline request associated with a first vendor and a second vendor;
responding to an interline request by at least executing a first set of instructions included in a first workbook associated with the interline request, the executing of the first set of instructions includes identifying the first vendor and the second vendor;
executing a second set of instructions included in a second workbook associated with the first vendor and a third set of instructions included in a third workbook associated with the second vendor; and
generating, based at least on a result of executing the first set of instructions, the second set of instructions, and the third set of instructions, a response for the interline request.

16. The method of claim 15, wherein the interline request comprises a shopping request to generate an interline itinerary containing a plurality of services and/or products provided by the first vendor and the second vendor.

17. The method of claim 16, wherein the response for the interline request includes a New Distribution Capability (NDC) offer with a plurality of New Distribution Capability (NDC) offer items corresponding to the plurality of services and/or products provided by the first vendor and the second vendor.

18. The method of claim 16, wherein the executing of the first set of instructions further includes searching a cache containing inventory data associated with the first vendor and the second vendor in order to generate the interline itinerary.

19. The method of claim 15, wherein the interline request comprises a booking request to purchase an interline itinerary containing a plurality of services and/or products provided by the first vendor and the second vendor.

20. A non-transitory computer readable medium storing instructions, which when executed by at least one data processor, result in operations comprising:
receiving an interline request associated with a first vendor and a second vendor;
responding to an interline request by at least executing a first set of instructions included in a first workbook associated with the interline request, the executing of the first set of instructions includes identifying the first vendor and the second vendor;
executing a second set of instructions included in a second workbook associated with the first vendor and a third set of instructions included in a third workbook associated with the second vendor; and
generating, based at least on a result of executing the first set of instructions, the second set of instructions, and the third set of instructions, a response for the interline request.

21-80. (canceled)
